(19) United States
(12) Patent Application Publication
(10) Pub. No.: US 2015/0186928 A1
(43) Pub. Date: Jul. 2, 2015

(54) REAL-TIME MARKETING PORTFOLIO OPTIMIZATION AND REAPPORTIONING

(71) Applicants: Anto Chittilappilly, Waltham, MA (US); Payman Sadegh, Alpharetta, GA (US); Rakesh Pillai, Kerala (IN)

(72) Inventors: Anto Chittilappilly, Waltham, MA (US); Payman Sadegh, Alpharetta, GA (US); Rakesh Pillai, Kerala (IN)

(21) Appl. No.: 14/584,588

(22) Filed: Dec. 29, 2014

Related U.S. Application Data
(60) Provisional application No. 61/922,695, filed on Dec. 31, 2013.

(51) Int. Cl. G06Q 30/02

(52) U.S. Cl. CPC G06Q 30/0244

(57) ABSTRACT

The present disclosure provides a detailed description of techniques used in systems, methods, and in computer program products for real-time marketing portfolio optimization and reapportioning. The claimed embodiments enable calculating and saving a maximum efficiency response curve of a media portfolio, the maximum efficiency response curve comprising a range of response values resulting from a set of media portfolio input characteristics. A user interacts with an interactive graphical user interface which accepts an input characteristic change to alter a spending apportionment in the media portfolio, relative to the calculated and saved a maximum efficiency response curve. Using the stored maximum efficiency response curve as a baseline, results of the reapportionment(s) are generated and displayed. To provide interactive response times, the change to the spending apportionment is modeled as an incremental change record that is used in conjunction with the retrieved stored representation of the maximum efficiency response curve.

### RELATED APPLICATIONS

This application claims priority, under 35 U.S.C. §119(e), to U.S. Provisional Application No. 61/922,695, filed on Dec. 31, 2013, entitled “REAL-TIME MARKETING PORTFOLIO OPTIMIZATION AND REAPPORTIONING”, which is expressly incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of computer-aided management of marketing and advertising campaigns and more particularly to techniques for high-performance prediction and display of resource allocations in marketing campaigns.

### BACKGROUND

Current marketing and advertising campaigns involve many channels (e.g., online display ads, TV ads, radio spots, newspaper ads, etc.) and the combination of channels are selected by a marketing manager to achieve one or more objectives (e.g., brand recognition, lead generation, prospect conversion, etc.). Spending or other activity in a given channel (e.g., placement of online display ads, placement of TV ads, placement of radio spots, etc.) can sometimes be increased in expectation of increasing the marketplace response. In some cases, spending in one channel can produce responses in other channels (e.g., more TV ads may increase the likelihood that a coupon in a newspaper ad will be clipped). A marketing manager might include many such channels in a media portfolio, and might apportion a media spend budget across the channels in a media portfolio in an effort to maximize the marketplace response. In some cases, additional stimulus via a particular channel might reach a “saturation point” such that the additional stimulus produces diminishing or negligible desired effects (e.g., more direct mail circulars may not produce any additional responses). The effects of increasing or decreasing spending in one channel may impact other channels, and the impacted channels may impact other channels, and so on.

In legacy environments, marketing managers have relied on subjective or soft data and/or anecdotal suggestions when making decisions regarding how a media spend budget should be apportioned across the set of channels in a media portfolio. However, recent advances allow the marketing manager to use mathematical techniques to quantitatively determine an apportioning of a given media spend budget across the channels in a given media portfolio. For example, one technique uses an iterative approach to determine an apportioning of a given media spend budget across the channels by iterating through the channels in the portfolio, and spending only so much of the budget on a given channel so as to approach but not exceed the saturation level of that channel. The iterations continue until either the budget is fully spent or until all channels (e.g., N channels) are predicted to produce results at or near their saturation levels. Although this technique often results in a quantitative apportionment, the selection of a first channel to consider in a first iteration has the effect of eliminating other channels for selection as the first channel. In some cases, the order of selection of the first through the Nth channel can have a profound effect on the overall effectiveness of the resulting apportionment.

Cost-effective techniques are needed to avoid the attendant problems of selecting the first through the Nth channel by applying numeric techniques (e.g., mathematical programming, linear programming, etc.) in combination with user-supplied constraints to perform exhaustive apportioning until a global optimal solution is reached. Numeric techniques are computationally intensive. Solving a multi-channel marketing apportioning scenario can often demand so much computational power that the solver cannot be felicitously used in an interactive setting (e.g., real-time adjustments). In fact, some media portfolios comprise many scores or even hundreds of channels, and finding a set of feasible apportioning solutions and/or solving for optimized apportioning solutions that most effectively achieve one or more objectives (e.g., optimization) can consume hours or days of compute time (e.g., not a real-time response)—even using current computing platform capabilities. Such delays can result in costly missed advertising and prospective conversion opportunities.

In addition to the aforementioned challenges faced by the marketing manager, the marketing manager might obtain new information pertaining to the spending levels and/or apportionments and/or advertising costs in the marketing manager's media portfolio. For example, a radio station might suddenly become unable to run the number of spots specified in the current media plan, and the marketing manager might want to quickly know how this change would affect the overall effectiveness of the media plan, and how the marketing budget should be reapportioned. Given the aforementioned computationally-intensive nature of optimization, the marketing manager might be forced to wait a long time before having a new apportionment. Meanwhile, additional new constraints might come to bear, and so on.

What is needed is a way to recalculate a media spend apportionment in an interactive setting such that new apportionments can be quickly calculated, displayed for user review, changed by the user, and again recalculated until the user is satisfied with the reapportionments.

None of the legacy approaches provide mechanisms for real-time marketing portfolio optimization and reapportioning, therefore improvements are needed.

### SUMMARY

The present disclosure provides an improved method, system, and computer program product suited to address the aforementioned issues with legacy approaches. More specifically, the present disclosure provides a detailed description of techniques used in methods, systems, and computer program products for forecasting and displaying the results of media portfolio input characteristics such as resource allocations in a marketing campaign.

Disclosed herein are methods, systems, and computer program products for computer-aided management of marketing and advertising campaigns. Operations commence upon calculating a maximum efficiency response curve of a media portfolio, the maximum efficiency response curve comprising a range of response values resulting from a set of media portfolio input characteristics, then saving a representation of the maximum efficiency response curve to a storage device. A user interacts with an interactive graphical user interface which accepts a user-input change to alter a spending apportionment in the media portfolio. Accepting the user-input change results in retrieving the stored maximum efficiency response curve which is used as a baseline to apply the user-altered spending change. Results of the reapportionment are then calculated and displayed. To provide interactive response times, changes to the spending apportionment are modeled as incremental change record(s) that are used with data retrieved from previously-stored representations (e.g., from unchanged channels) of the media plan (e.g., a maximum efficiency response curve, a spending plan, etc.). A perturbation event to alter the media portfolio input characteristics can comprise a variation to alter a spending apportionment in a particular channel. A previously-stored maximum efficiency response curve is used as a baseline to apply the user-altered spending change such that the variation in the one particular channel does not result in an exhaustive or iterative recalculation of a second maximum efficiency response curve to reflect the effect of the variation in the one channel over all other channels in the media portfolio.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts a chart illustrating an approach for applying a variation in spending across multiple media channels, according to some embodiments.

FIG. 1B1 and FIG. 1B2 depict alternative reapportionments of a budget across multiple media channels, according to some embodiments.

FIG. 1C1 and FIG. 1C2 depict techniques to recalculate a media spend apportionment in an interactive setting such that new apportionments can be quickly calculated and presented to a user, according to some embodiments.

FIG. 1D depicts a user interaction environment for forecasting and displaying results of resource allocations in a marketing campaign, according to some embodiments.

FIG. 1E shows efficiency curves plotted in an interactive interface used in forecasting and displaying results of resource allocations in a marketing campaign, according to some embodiments.

FIG. 1F shows reallocation values plotted in an interactive interface used in forecasting and displaying results of resource allocations in a marketing campaign, according to some embodiments.

FIG. 2 depicts a configuration screen used in a system for forecasting and displaying results of resource allocations in a marketing campaign, according to some embodiments.

FIG. 3A is a block diagram of a subsystem for precalculating efficient frontier data as used in systems for forecasting and displaying results of resource allocations in a marketing campaign, according to some embodiments.

FIG. 3B depicts a stimulus-response curve characterizing saturation behavior as used in systems for forecasting and displaying results of resource allocations in a marketing campaign, according to some embodiments.

FIG. 3C depicts a stimulus-response curve characterizing slow uptake behavior as used in systems for forecasting and displaying results of resource allocations in a marketing campaign, according to some embodiments.

FIG. 3D depicts a data flow for an efficient frontier algorithm as used in systems for forecasting and displaying results of resource allocations in a marketing campaign, according to some embodiments.

FIG. 4A depicts multi-channel responses to apportioning stimulus across multiple channels as used in systems for forecasting and displaying results of resource allocations in a marketing campaign, according to some embodiments.

FIG. 4B depicts improved multi-channel responses to apportioning stimulus across multiple channels as used in systems for forecasting and displaying results of resource allocations in a marketing campaign, according to some embodiments.

FIG. 5 is a block diagram of a subsystem for precalculating exhaustive apportioner data as used in systems for forecasting and displaying results of resource allocations in a marketing campaign, according to some embodiments.

FIG. 6 shows reallocation values plotted in proximity to efficiency curves in an interactive interface as used in forecasting and displaying results of resource allocations in a marketing campaign, according to some embodiments.

FIG. 7A shows reallocation of resources across multiple channels using slider bars in an interactive interface as used in forecasting and displaying results of resource allocations in a marketing campaign, according to some embodiments.

FIG. 7B shows an interactive reallocation of resources across multiple channels using slider bars in an interactive interface as used in real-time marketing portfolio optimization and reapportioning, according to some embodiments.

FIG. 8 is a block diagram of a system for displaying results of resource allocations in a marketing campaign, according to some embodiments.

FIG. 9 is a block diagram of a system for generating and displaying results of resource allocations in real time for marketing portfolio optimization and reapportioning, according to some embodiments.

FIG. 10 depicts a block diagram of an instance of a computer system suitable for implementing an embodiment of the present disclosure.

### DETAILED DESCRIPTION

### Overview

Current marketing and advertising campaigns involve many channels (e.g., online display ads, TV ads, radio spots, newspaper ads, etc.) and each channel is selected by a marketing manager to achieve a particular objective (e.g., brand recognition, lead generation, prospect conversion, etc.). Spending or other activity in a given channel (e.g., placement of online display ads, placement of TV ads, placement of radio spots, etc.) can sometimes be increased in expectation of increasing the marketplace response. In some cases, spending in one channel can produce responses in other channels (e.g., more TV ads may increase the likelihood that a coupon in a newspaper ad will be clipped). A marketing manager might include many such channels in a media portfolio, and might apportion a media spend budget across the channels in a media portfolio in an effort to maximize the marketplace response. In some cases, additional stimulus via a particular channel might reach a “saturation point” such that the additional stimulus produces diminishing or negligible desired effects (e.g., more direct mail circulars may not produce any additional responses). The effects of increasing or decreasing spend in one channel may impact other channels, and the impacted channels may impact other channels, and so on. In the face of such complexity, a marketing manager would want to know how to efficiently apportion the budget across the channels in their marketing portfolio (e.g., determine a media spending plan) so as to most effectively achieve the objectives of the campaign.

Moreover, during the course of prosecuting the media spending plan, unplanned events can occur. For example, a TV series is canceled (e.g., preventing placement of ads during airing of that series), or a radio station ceases to air (e.g., preventing placement of spots on that radio station). In the face of such unplanned events, a marketing manager would need to quickly evaluate many variations in spending that concurrently observes the changes or perturbations from the original plan, the changes due to single-channel and cross-channel effects, and/or response metrics such as return on investment (ROI). Techniques for calculating and displaying predictions resulting from a particular reallocation of spending in a media portfolio are needed.

To address the aforementioned problem, the techniques described herein enable calculating and saving a maximum efficiency response curve of a media portfolio, the maximum efficiency response curve comprising a range of response values resulting from a set of media portfolio input characteristics. A user interacts with an interactive graphical user interface which accepts an input characteristic change to alter a spending apportionment in the media portfolio. Using the stored maximum efficiency response curve as a baseline, results of the reapportionment are generated and displayed. To provide interactive response times, the change to the spending apportionment is modeled as an incremental change record that is used in conjunction with the retrieved stored representation of the maximum efficiency response curve.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

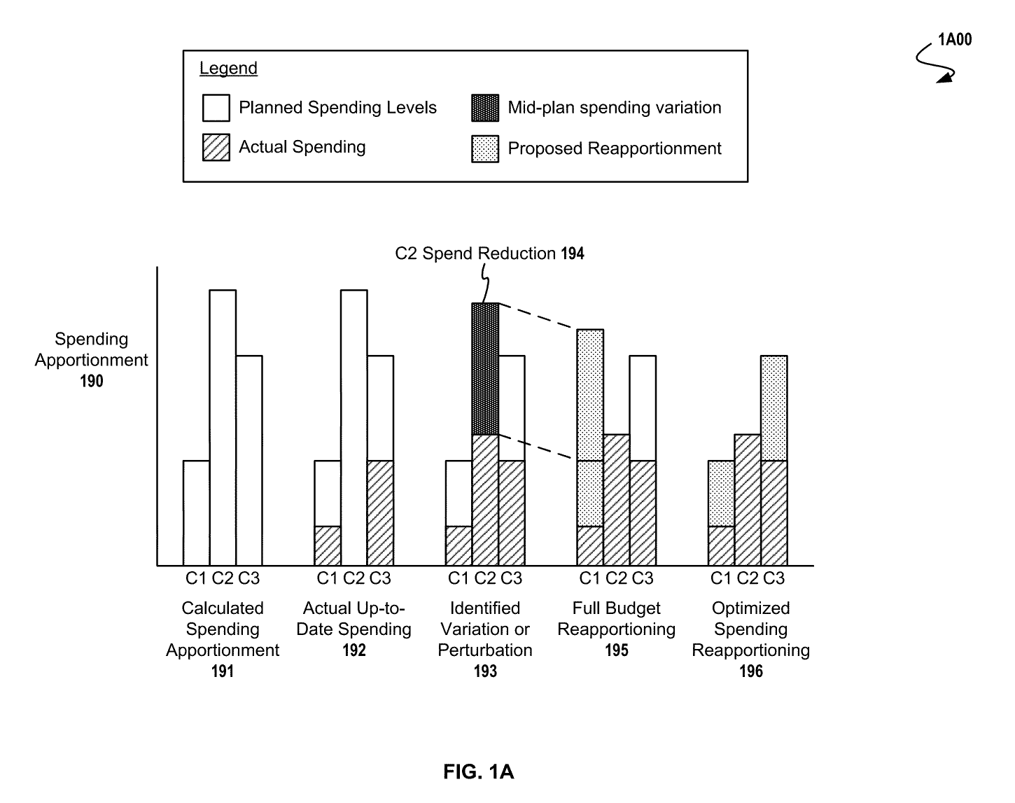

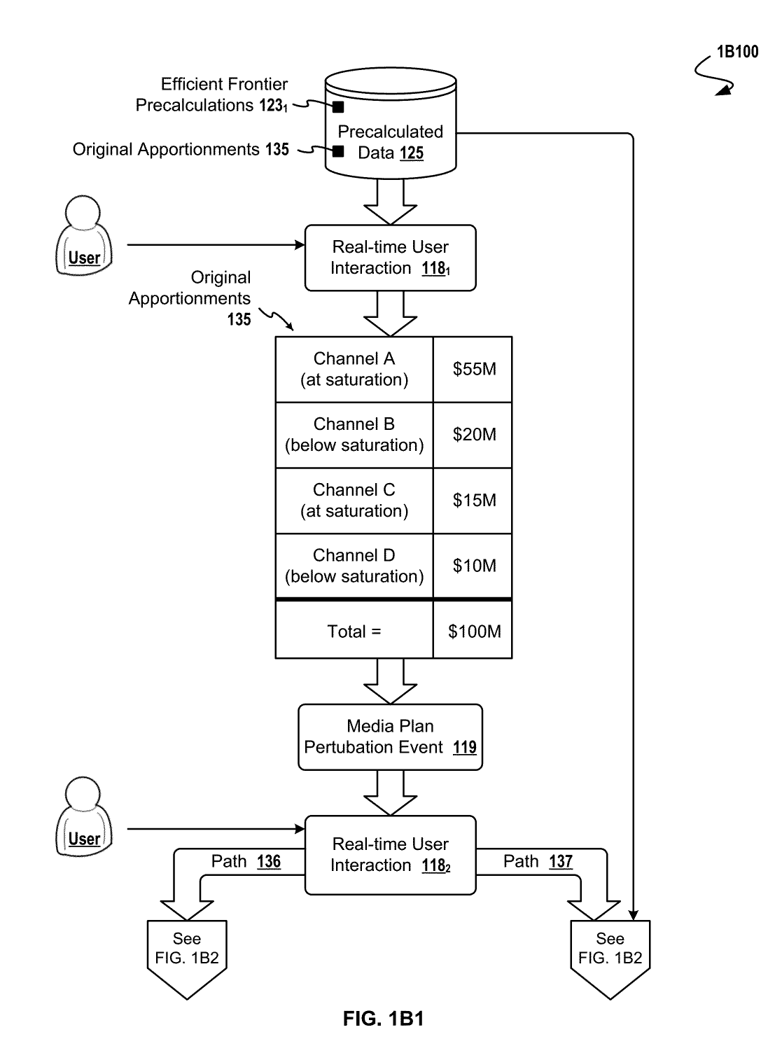

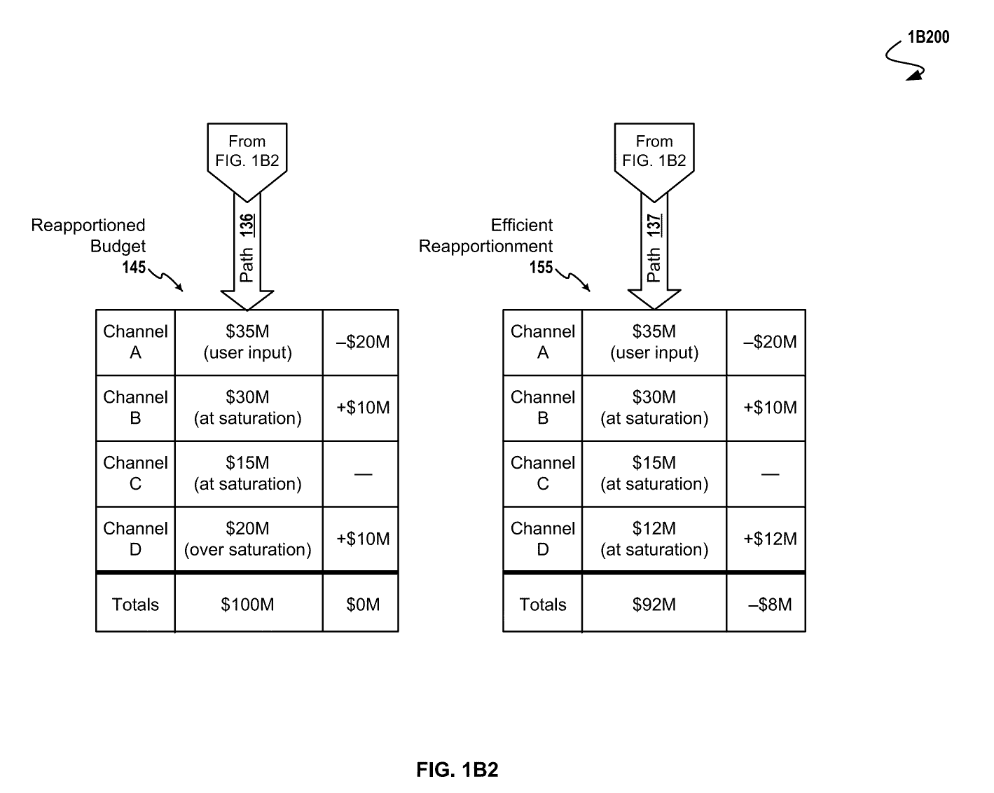

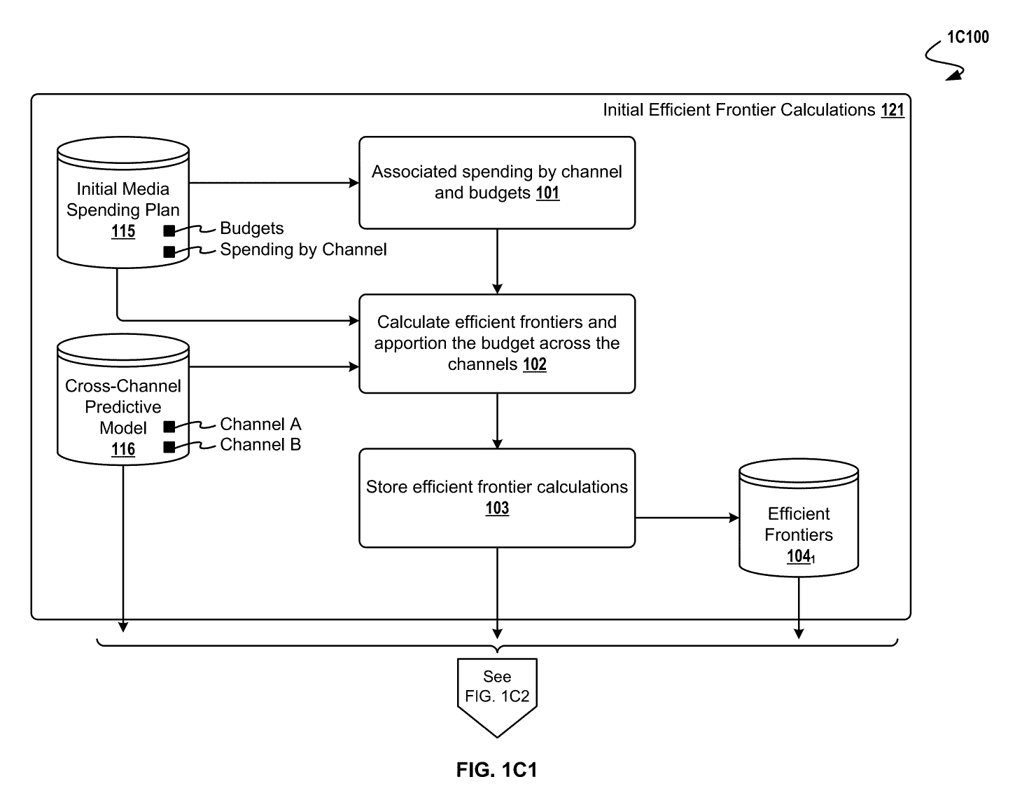

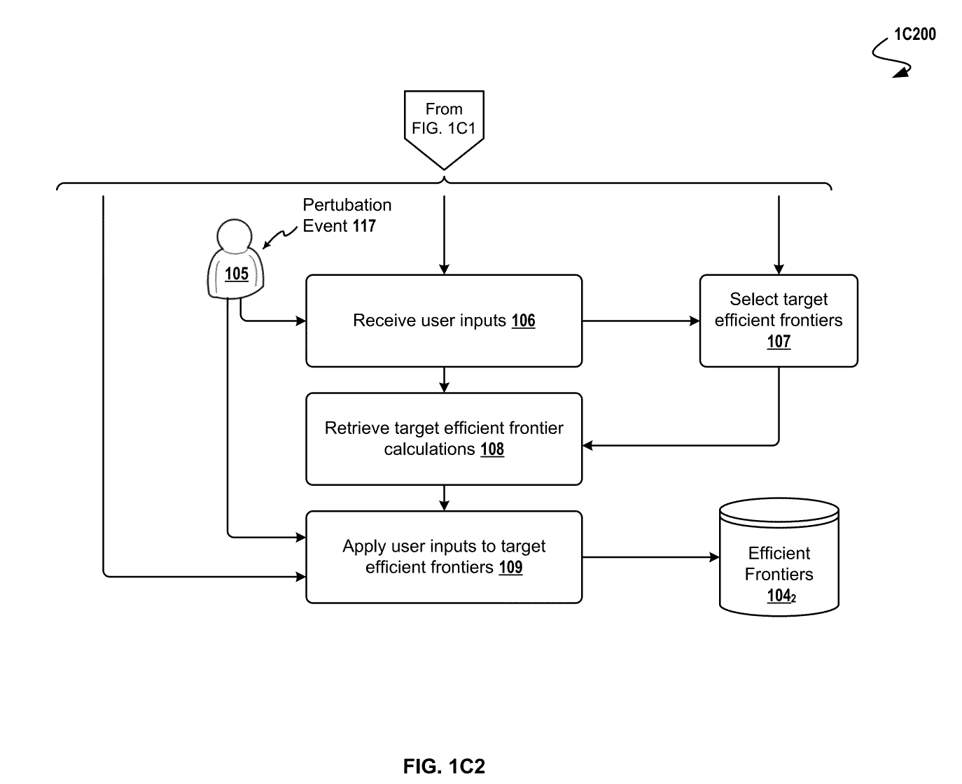

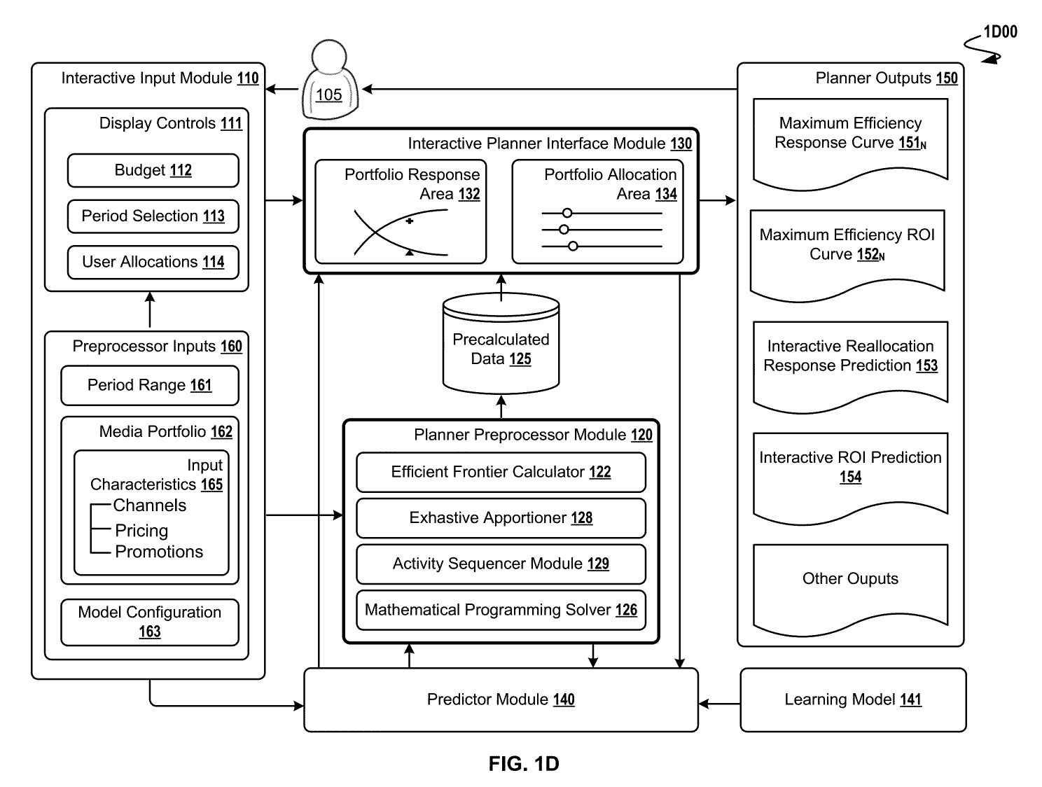

FIG. 1A depicts a chart 1A00 illustrating an approach for applying a variation in spending across multiple media channels.

As shown in chart 1A00, each group of bars represents a marketing campaign comprising three media channels (e.g., C1, C2, and C3), for which channels a spending apportionment 190 is applied. For example, a calculated spending apportionment 191 was earlier determined using any known technique, including any of the techniques presented hereunder (e.g., see FIG. 1D, including efficient frontier calculator 122, exhaustive apportioner 128, mathematical programming solver 126, etc.), and was stored (e.g., see FIG. 1D including precalculated data 125). At some moment in time, the media portfolio manager might learn that one or more variations in spending are needed. For example, TV programming might change suddenly (e.g., a series is cancelled), and the previously planned spending apportioned to a sequence of TV ads for a TV program (e.g., C2) cannot be placed. In such a case, the media portfolio manager might collect an actual up-to-date spending 192 over the three channels and consider how to reapportion the spending to other channels.

In one case, the media portfolio manager might determine an identified variation or perturbation 193 and reapportion a C2 spend reduction 194 (e.g., reduction in spending in channel C2 due to lack of TV ad space) to the remaining channels C1 and C3 in a full budget reapportioning 195. In this scenario, the entire amount of the perturbation (e.g., C2 spend reduction 194) is reapportioned to the other channels, and the original total amount of spending as was used in the calculated spending apportionment 191 is spent.

In other cases, certain techniques such as are discussed hereunder can reapportion in an efficient manner (e.g., in accordance with an efficient frontier) that most effectively achieves one or more objectives (e.g., maximize ROI) of the marketing campaign (e.g., optimization). As shown in an optimized spending reapportioning 196, such techniques can most efficiently and effectively achieve the objectives of the campaign by merely reducing the spending level by an amount equal to the C2 spend reduction 194, and not reapportioning the variation to channels C1 and C3.

The foregoing full budget reapportioning 195 and optimized spending reapportioning 196 depict alternatives that can be considered by the media portfolio manager. More specifically, the full budget reapportioning 195 observes a total spending objective (e.g., spend all of the given budget), while the optimized spending reapportioning 196 observes an efficiency objective (e.g., maximize ROI).

Disclosed hereunder are techniques that enable reapportioning in an efficient manner so as to optimize one or more objectives of a media spending plan (e.g., return on investment of the spending). Moreover, the disclosed techniques can apply a proposed spending change, and perform a reapportionment based, in part, on a precalculated spending apportionment. Some such techniques are discussed as follows.

FIG. 1B1 and FIG. 1B2 depict alternative reapportionments of a budget across multiple media channels.

Specifically, a chart 1B100 and a chart 1B200 depict a first path 136 and a second path 137 providing alternative reapportionments following a media plan perturbation event 119. More specifically, using any known techniques, a cross-channel model and an efficient spending plan can be generated and stored (e.g., into a non-volatile repository) as precalculated data 125. Precalculated data 125 can also include a set of efficient frontier precalculations 123₁. A user, through a real-time user interaction 118₁, uses the precalculated data 125 to simulate spending scenarios, and at least some of such spending scenarios result in a set of original apportionments 135. As shown, the original apportionments 135 include spending across four channels: channel A spending is $55M, channel B spending is $20M, channel C spending is $15M, and channel D spending is $10M, which apportionments results in an efficient spending plan at least inasmuch as spending in channel A is at saturation, spending in channel B is below saturation, spending in channel C is at saturation, and spending in channel D is below saturation.

At some later point, the media plan perturbation event 119 occurs (e.g., some previously planned spending cannot be spent as planned), raising the need for a reapportionment by the user through a real-time user interaction 118₂. As earlier indicated, given the media plan perturbation event 119, one approach is to merely reapportion the amount of the perturbation across the channels up to the amount of the original budget, without regard to the effect of such reapportioning, in order to quickly (e.g., in real time) deploy a reapportioning. This alternative is depicted in chart 1B100 and chart 1B200 by first path 136, leading to a reapportioned budget 145.

The media plan perturbation event 119 can also raise a signal to reapportion in an efficient manner (e.g., maximize ROI of the spending). As earlier indicated, legacy approaches to such optimized apportionment (e.g., using numeric techniques to exhaustively evaluate scenarios and optimize the apportionment) is computationally intensive, and does not support the real-time user interaction 118₂. However, following the techniques disclosed herein, embodiments can provide the real-time user interaction 118₂ required (e.g., by a media manager) by modeling the change in the media portfolio spending as an incremental change record that is combined with the precalculated data 125 (e.g., efficient frontier precalculations 123₁) to perform interactive simulations of spending reapportionment scenarios, including recalculating of spending scenarios that consider the cross-channel effects as were stored in the precalculated data 125. This approach is depicted in chart 1B100 and chart 1B200 by second path 137, leading to an efficient reapportionment 155.

In the example of FIG. 1B1 and FIG. 1B2, the media plan perturbation event 119 is in the form of cancellation of a TV series, resulting in an inability to buy ad placements during that series, which in turn results in an inability to spend the full planned amount of $55M in channel A (e.g., see original apportionments 135). For both the reapportioned budget 145 and the efficient reapportionment 155, the spending in channel A is reduced by $20M to $35M. The $20M is available to be spent in the other channels of the media portfolio. For the reapportioned budget 145, the $20M is split between channel B and channel D. However, while the additional $10M for channel B brought the spending in channel B to saturation, the additional $10M for channel D drove the spending in channel D to over saturation, resulting in an inefficient spending level for channel D.

Alternatively, given the techniques disclosed herein, the $20M can be reallocated across the other channels—but only insofar as additional spending in the other channel(s) returns an optimized aggregate performance (e.g., at least as good as the original ROI). As shown, the efficient reapportionment 155 varies spending by only $8M even though the media plan perturbation event 119 resulted in an available $20M. In this example, the spending in channel D is increased only up to an amount at or below saturation (e.g., +$2M). As such, the simulation model predicts that additional spending in channel D does not improve the return of the media portfolio in aggregate once spending in channel D reaches $12M.

As earlier indicated, the results of spending in one channel can affect the performance of another channel, and the results of that channel can affect the performance of another channel, and so on, and a user such as a media portfolio manager can seize advantage of a system to recalculate a media spend apportionment in an interactive setting. Such a system is shown and discussed below.

FIG. 1C1 and FIG. 1C2 depict techniques to recalculate a media spend apportionment in an interactive setting such that new apportionments can be quickly calculated and presented to a user, according to some embodiments.

As suggested above, a modern marketing and advertising campaign might include a media portfolio, which in turn may involve interrelated channels. The effects of increasing or decreasing spend in one channel may impact other channels, and the impacted channels may impact still other channels, and so on. In the face of such complexity in a dynamic environment where a media spending plan involves scores or hundreds of channels, a marketing manager faces multiple challenges, including determining an efficient media spending plan and reapportioning spend plans in real-time during the period of prosecution of a media spending plan.

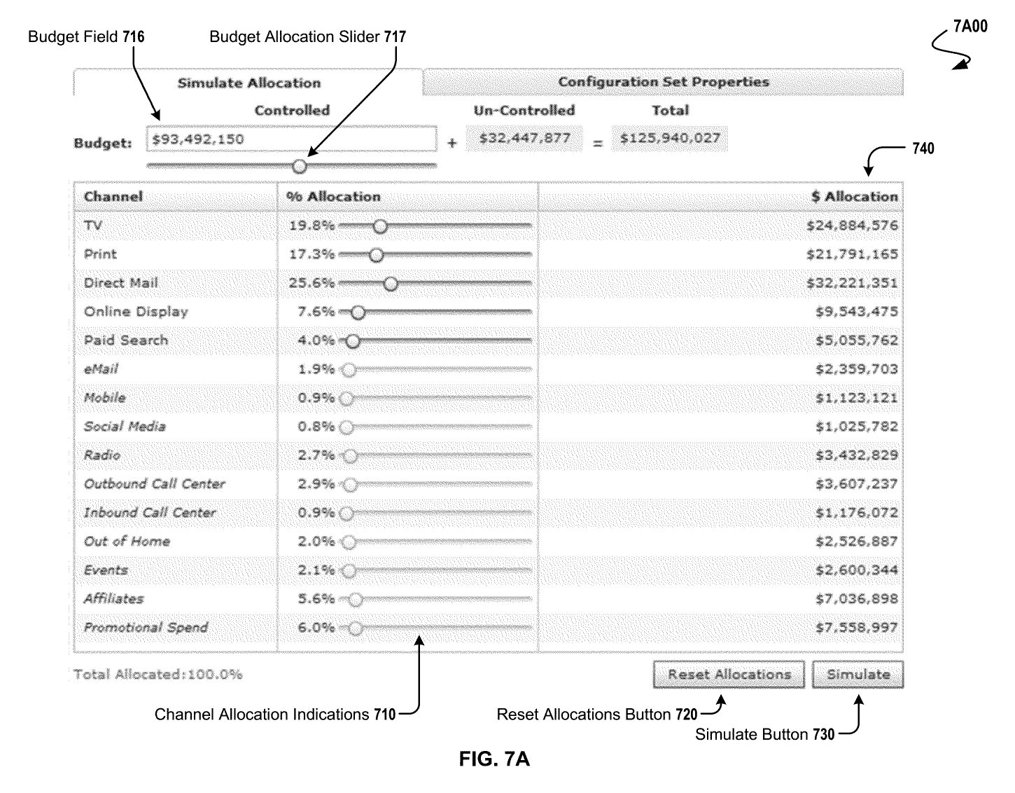

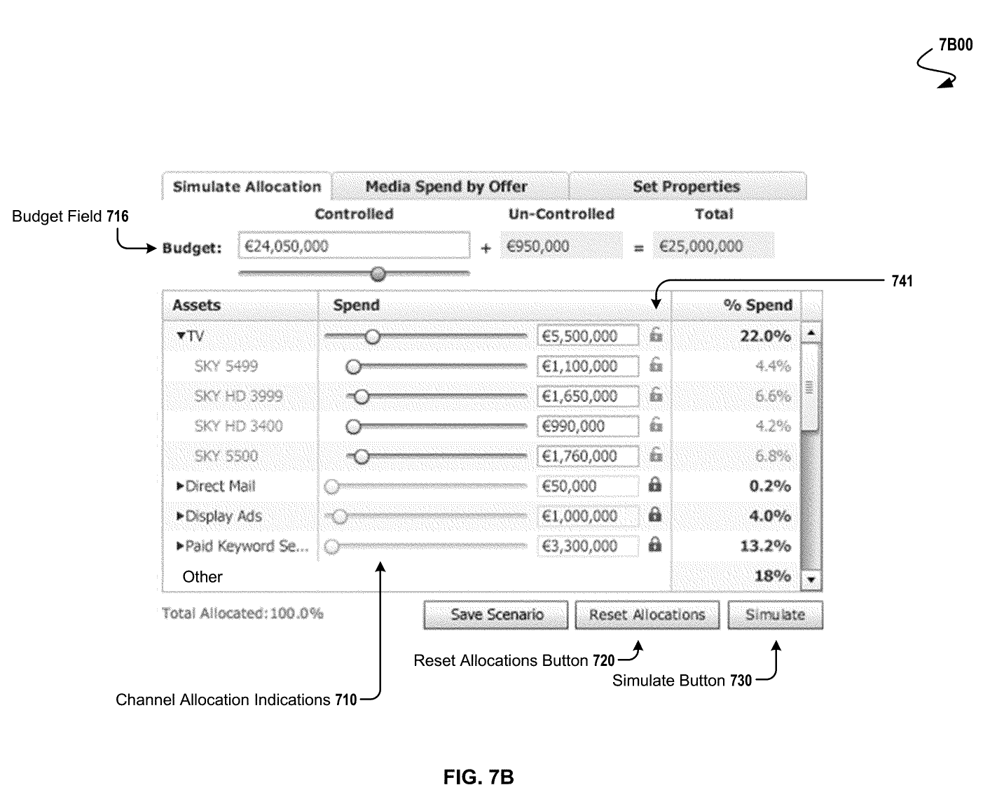

Techniques to interactively display marketing campaign predictions and/or metrics (e.g., predicted revenue changes, predicted return on investment, etc.) resulting from a particular mix of spending and/or resulting from a particular set of media plan characteristics of a media plan are needed, and are the subject of depiction and discussion of FIG. 1C1 and FIG. 1C2. Techniques to capture user-specified changes in spending in one or more channels of the media portfolio are also discussed herein (i.e., see FIG. 7A and FIG. 7B).

### Sample Use Model

When defining a marketing and advertising campaign, many channels (e.g., for carrying out marketing and advertising activities) might be considered in a certain mix and/or schedule. For example, an advertising campaign might include a direct mail campaign followed by two weeks of radio spots, and followed by point-of-purchase coupons or other promotion for the product or service being advertised.

In such a scenario, and in other more complex scenarios, an advertiser would want to predict how increasing spending on one or another channel would affect the overall effectiveness of the campaign. The effect of increasing spending on one or another channel has long been studied, and legacy models quantify the effect of increasing spending on one or another channel in terms of measurable results. For example, if 1000 coupons were mailed to 1000 households, and those coupons resulted in 40 coupon redemptions for product purchases, the revenue from the purchases (e.g., “return”) and the cost of prosecuting the coupon portion of the campaign (e.g., “investment”) can be used to determine a return on investment.

Legacy techniques predict future performance of a particular marketing activity based on past performance of that particular marketing activity. However, modern advertising campaigns often include activities in multiple channels (e.g., online display, direct mail, radio, TV, etc.), some of which channels interact with other channels in complex ways. Legacy techniques fail to account for intra-channel phenomenon such as saturation (e.g., listeners get tired of hearing the same advertisement, and “tune out”) and for extra-channel phenomenon such as cross-channel effects (e.g., a direct mail coupon will receive more responses if mailed one week after a blitz of radio spots). Further, certain channels have natural and/or policy constraints and/or other constraints (e.g., there are only a finite number of spots available for a TV ad on the “Evening News”).

Further details regarding a general approach to cross-channel predictive modeling are described in U.S. Application No. 61/922,680 (Attorney Docket No. VISQ.P0008P) entitled, “MEDIA SPEND OPTIMIZATION USING CROSS-CHANNEL PREDICTIVE MODEL”, filed Dec. 31, 2013, which is expressly incorporated herein in its entirety by reference.

Referring again to FIG. 1C1 and FIG. 1C2, subsystem 1C100 includes a set of operations (e.g., initial efficient frontier calculations 121) that commence upon receipt of an initial media spending plan 115, including associated spending by channel and budgets (see operation 101). The initial media spending plan 115 and information from a cross-channel predictive model 116 (e.g., for channel A, channel B, etc.) can then be used to calculate a set of efficient frontiers 104₁ (e.g., for each channel) and apportion the budget across the channels (see operation 102). The efficient frontiers 104₁ can then be stored in a non-volatile storage device such as a disk drive (see operation 103). Such storage can comprise any form of storage and/or of representation. For example, the efficient frontiers 104₁ can be represented in XML, and/or in a text format, and/or in a binary format, or any combination. In fact, and as shown, there are many techniques available to calculate an efficient frontier (e.g., see operation 102). As well, there are many techniques to store an efficient frontier for later retrieval (e.g., see operation 103).

Referring now to a subsystem 1C200 connected to subsystem 1C100 (e.g., see FIG. 1C1 and FIG. 1C2), an unplanned event (e.g., perturbation event 117) might signal a change to the initial media spending plan 115 is needed, causing a user 105 to want to interactively determine how to reapportion the spending in the media portfolio. Subsystem 1C200 can then receive user inputs (see operation 106) that, in part, server to select a set of target frontiers from efficient frontiers 104₁ (see operation 107). For example, user 105 might select a certain efficient frontier stored from efficient frontiers 104₁ that was calculated using an iterative efficient frontier calculator, or a user might select a stored efficient frontier that was calculated using an exhaustive apportioner. Subsystem 1C200 can retrieve calculations for the selected target efficient frontiers (see operation 108), and can apply user inputs over the media plan (see operation 109) using the retrieved efficient frontier calculations to determine an updated set of efficient frontiers 104₂. In one or more embodiments, information from cross-channel predictive model 116 can also be used to determine the updated set of efficient frontiers 104₂. For example, a user might respond to a perturbation by indicating a change in spending in one or more channels of the media portfolio as perturbations to the previously stored media plan (e.g., initial media spending plan 115). Strictly as further examples, the spending perturbations can be applied in accordance with rules or heuristics such as:
When the spending perturbations result in a net amount of spending to be applied over the portfolio, apportion incremental amounts to the unperturbed channels but only increase spending in a particular channel up until the aggregate media spending plan returns a specified ROI;
When the spending perturbations result in a net amount of spending to be applied over the portfolio, apportion incremental amounts to the unperturbed channels but only increase spending in a subject channel up until the point that the subject channel reaches saturation;
When the spending perturbations result in a net amount of spending to be applied over the portfolio, apportion incremental amounts to the unperturbed channels in a particular order (e.g., select the highest spend channels first and apportion iteratively to the next successively smaller spend channels); and
Other techniques as implemented in one or more embodiments.

FIG. 1D depicts a user interaction environment 1D00 for forecasting and displaying results of resource allocations in a marketing campaign. As an option, one or more instances of user interaction environment 1D00 or any aspect thereof may be implemented in the context of the architecture and functionality of the embodiments described herein.

As shown, a user 105 interacts with an interactive planner interface module 130 using various display components (e.g., text boxes, sliders, pull-downs, widgets, etc.) that serve to capture various inputs using interactive input module 110. The interactive planner interface module 130 comprises a portfolio allocation area 134 and a portfolio response area 132. The user can use sliders or other widgets to vary any one or more media plan characteristic. For example, the user can use sliders or other widgets to vary a set of media portfolio input characteristics 165 of the user's media portfolio 162. As another example, the user can use sliders or other widgets to allocate stimulus, set spending levels, define end-user pricing, define promotions, etc. or vary any other components of the media portfolio input characteristics 165 of the user's media portfolio 162 and/or of any other aspects of the user's media plan. In some cases, the user can use sliders or other widgets to model user response to any one or more media plan characteristic.

The efficacy of a particular apportionment to channels in a media portfolio can be predicted by sending the details of the particular apportionment from the interactive planner interface module 130 to a predictor module 140, which in turn returns the predicted market response to the particular apportionment back to the interactive planner interface module 130. As depicted, the predictor module 140 uses a learning model 141 that is trained on historical data. Further details pertaining to the learning model 141 can be found in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013. The learning model can incorporate end-user responses to any sorts of values or changes in the media plan (e.g., values or changes related to product pricing, channel spend, advertising material, radio spot copy, etc.), and can predict market response(s) from any one or more of the aforementioned values or changes.

In addition to presenting a predicted market response to a particular apportionment (e.g., in the form of curves plotting a response as a function of stimulus), the interactive planner interface module 130 can produce various planner outputs 150, which can comprise any forms of output (e.g., displayed curves, tables, reports, etc.) and can include a maximum efficiency response curve 151_{N}, a maximum efficiency ROI curve 152_{N}, an interactive reallocation response prediction 153, and/or an interactive ROI prediction 154.

The aforementioned predictor module 140 can operate in an interactive setting (e.g., in cooperation with interactive planner interface module 130) and/or in an offline or batch mode (e.g., in cooperation with a planner preprocessor module 120). The planner preprocessor module 120 can perform batch processing that results in storage of precalculated data 125, which in turn can be used by the interactive planner interface module 130. In particular, a query or scenario can be formed by user 105, input into the interactive planner interface module 130, and through use of the precalculated data 125, the interactive planner interface module can return results interactively (e.g., without closing the screen or application). The precalculated data 125 can result from any one or more of various modules within the planner preprocessor module 120. Strictly as an illustrative example, the planner preprocessor module 120 comprises:
An efficient frontier calculator 122;
An exhaustive apportioner 128;
An activity sequencer module 129; and
A mathematical programming solver 126.

The planner preprocessor module 120 can be configured to receive instances and/or sequences of preprocessor inputs 160 that correspond to various user-specified ranges and/or selections used to calculate and output the precalculated data 125. For example, user 105 might specify a period range 161 over which the user intends to prosecute the media campaign. User 105 can specify various channels or other characteristics (e.g., media portfolio input characteristics 165) of the user's media portfolio 162, and the user 105 can specify a model configuration 163.

Using such a model configuration (e.g., model configuration 163), the predictor module 140 can produce predictions as to how the user's media portfolio 162 would respond to various stimuli. For example, using a selected instance of the model configuration 163, the predictor module 140 can predict a change in response or responses (e.g., an increase of sales, an increase of inquiries, etc.) to a particular stimulation (e.g., an increase in spending, a reapportionment of the budget, etc.).

Further configurations can be specified by the user 105. For example, a display component for presenting and capturing various inputs and settings at interactive input module 110 can comprise display controls 111 that alter the look-and-feel and presentation of the display (e.g., on a computer or smart phone screen). Such display controls can include presentation and capturing aspects of a budget 112 (e.g., a selected currency), a period selection 113 (e.g., days, weeks, months, quarters, etc.), and/or user allocations 114 (e.g., default user allocations).

A selection of techniques for interacting with a user are shown and discussed as pertaining to FIG. 1E and other figures below. In exemplary cases, the portfolio response area 132 is populated by default with one or more maximum efficiency response curves and one or more maximum efficiency ROI curves.

FIG. 1E shows efficiency curves plotted in an interactive interface 1E00 used in forecasting and displaying results of resource allocations in a marketing campaign. As an option, one or more instances of interactive interface 1E00 or any aspect thereof may be implemented in the context of the architecture and functionality of the embodiments described herein. Also, the interactive interface 1E00 or any aspect thereof may be implemented in any desired environment.

As shown, the interactive interface 1E00 comprises a portfolio allocation area 134 and a portfolio response area 132. The portfolio allocation area 134 can comprise a container that includes:
A budget specification field 171 to receive user input as to a level of spend (e.g., maximum, minimum, range, etc.);
A stimulus allocation area 175 to receive user input as to an allocation (e.g., a spend value or a percentage value) that apportions an amount of spend or percentage of spend to a set of media portfolio constituents (e.g., media channels);
A reset button or reset field 172 to reset apportionments to a set of default values or initial state values; and
A simulate button or simulate field 176 to launch a simulation or calculation of a predicted portfolio response.

The predicted portfolio response can be displayed in the portfolio response area 132. The data displayed in the portfolio response area 132 (e.g., a maximum efficiency response curve 151₁, a maximum efficiency ROI curve 152₁) can be plotted on an XY plot (as shown), and the display can be manipulated using a period selection field 181 and/or a scrollbar or scroll wheel or other scroll control or other known-in-the-art manipulation techniques. Multiple Y-axis scales can be presented in the graphs shown in the portfolio response area 132.

Those skilled in the art will recognize that a maximum efficiency response curve (e.g., maximum efficiency response curve 151₁) can be calculated for a media portfolio, and can be displayed even in the absence of a budget specification. An optional budget specification (e.g., as provided in the budget specification field 171) can be plotted in the portfolio response area 132 (e.g., as a vertical line).

As earlier indicated, the stimulus allocation area 175 can receive user input as to an allocation (e.g., a spend value or a percentage value) that apportions an amount of spend or percentage of spend to a set of media portfolio constituents (e.g., media channels), and the given apportionment can be simulated on demand (e.g., upon user indication via the simulate field 176). The results of the simulation (e.g., using a specific budget and a specific apportionment of media spends) can be plotted on or near the curves in the portfolio response area 132 (e.g., see FIG. 1F). The user can reallocate and simulate any number of times. For each iteration, the results of the simulation are plotted on or near the curves in the portfolio response area 132 as reallocation values.

FIG. 1F shows reallocation values plotted in an interactive interface 1F00 used in forecasting and displaying results of resource allocations in a marketing campaign. As an option, one or more instances of interactive interface 1F00 or any aspect thereof may be implemented in the context of the architecture and functionality of the embodiments described herein. Also, the interactive interface 1F00 or any aspect thereof may be implemented in any desired environment.

As shown, interactive interface 1F00 comprises a reallocation response value 173₁ and a reallocation ROI value 174₁. As earlier indicated, exemplary embodiments populate the portfolio response area 132 with a maximum efficiency response curve 151₂ and a maximum efficiency ROI curve 152₂. A reallocation response value 173₁ and a reallocation ROI value 174₁ can be plotted on or near the maximum efficiency response curve 151₂ and on or near the maximum efficiency ROI curve 152₂, respectively, and as shown.

The budget can be changed and/or the allocation can be changed, and the scenario can be re-simulated. After re-simulation, a new reallocation response value is plotted and a new reallocation ROI value is plotted.

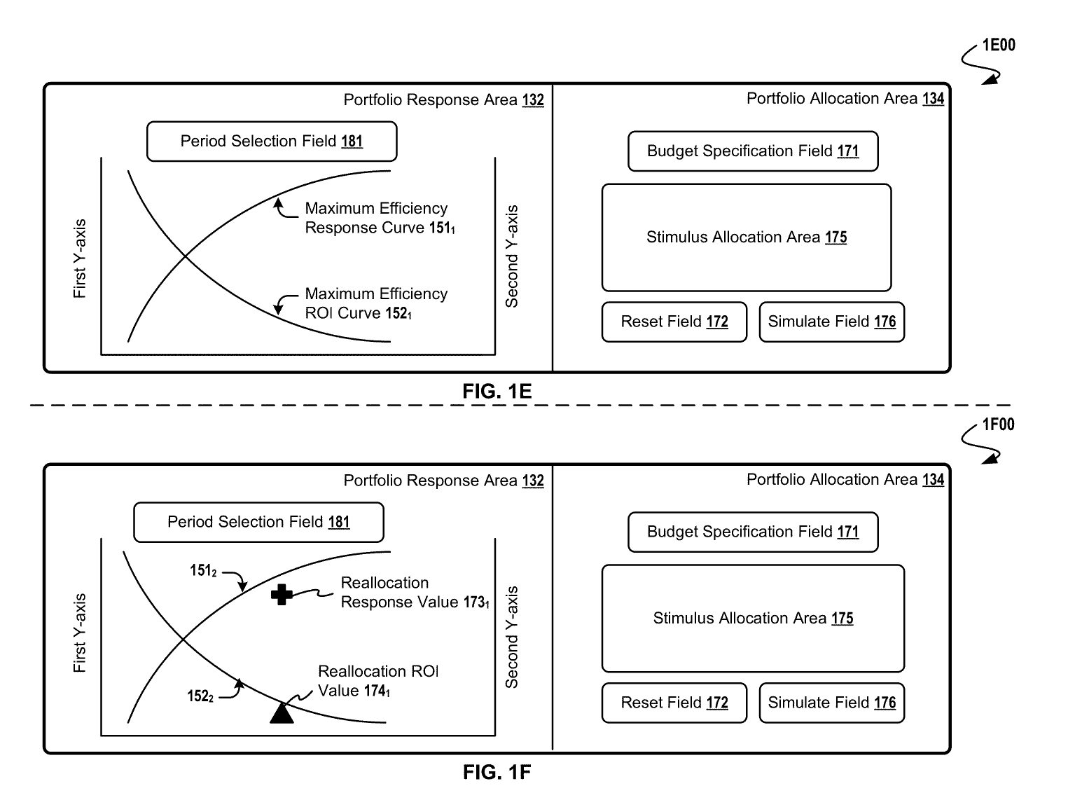

FIG. 2 depicts a configuration screen 200 used in a system for forecasting and displaying results of resource allocations in a marketing campaign. As an option, one or more instances of configuration screen 200 or any aspect thereof may be implemented in the context of the architecture and functionality of the embodiments described herein. Also, the configuration screen 200 or any aspect thereof may be implemented in any desired environment.

As shown, the configuration screen 200 supports defining various types of inputs (e.g., preprocessor inputs 160) for planner preprocessor module 120. Specifically, the configuration screen 200 supports defining various types of configuration settings 202. For example, configuration screen 200 supports a user interface to define a model and/or model configurations to be used by the predictor module (e.g., see model selection 204). In this embodiment, once a model has been selected then channels used in the model can be selected (see channel selection 206). A time period over which simulations are performed and/or results are calculated can be defined (see period range 161).

In exemplary embodiments, the configuration settings are interpreted as follows:
The configuration settings 202 define the base configuration for which a yield curve is generated.
The period range 161 includes a definition of a prediction period for which the yield curve is generated.
The channel selection 206 can be implemented as a multi-value channel drop-down from which channels can be highlighted or otherwise selected. The selected channels can be represented as channel allocation sliders such as, for example, in the portfolio allocation area 134 (see FIG. 1D).
A minimum budget and maximum budget can be established using a user minimum budget value 208 and a user maximum budget value 209, respectively. Budgets are used in calculations and are displayed for user interaction. Budgets are further discussed below (e.g., see FIG. 7A and FIG. 7B).
A budget and/or any spending amount can be entered in any currency, and a selector (e.g., currency selection 211) can be used to establish a common or normalized currency regime for display. Alternatively, any budget or spending amount can be displayed at any time in any selected currency.

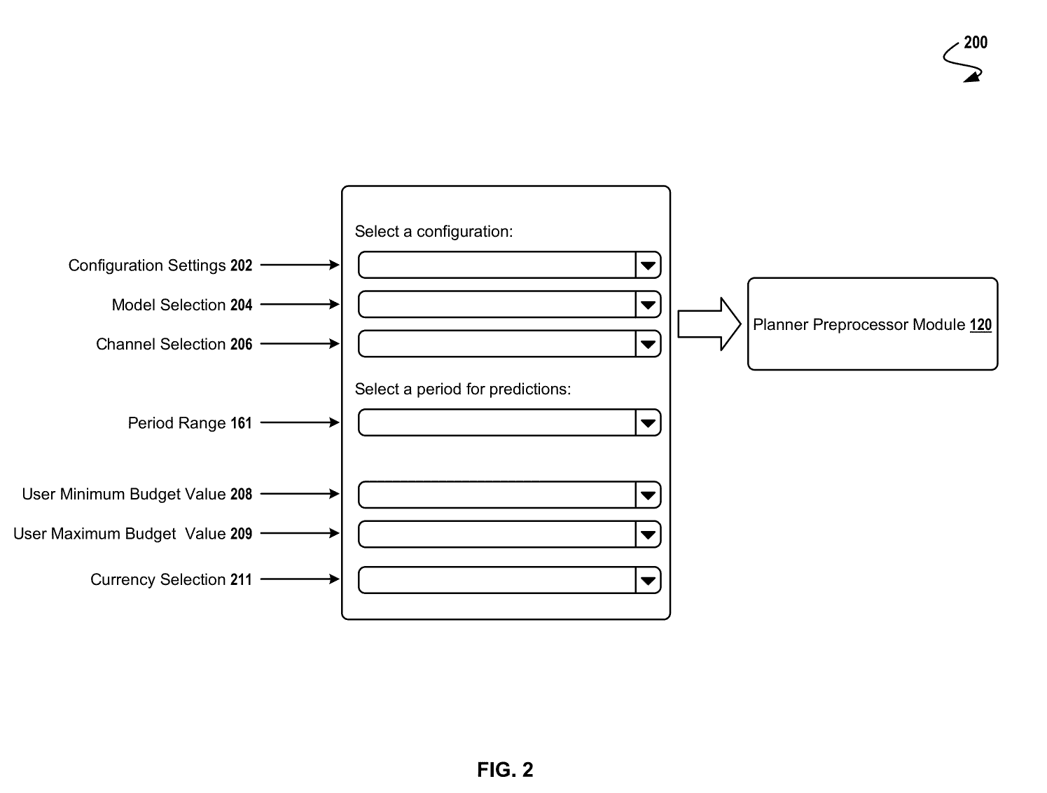

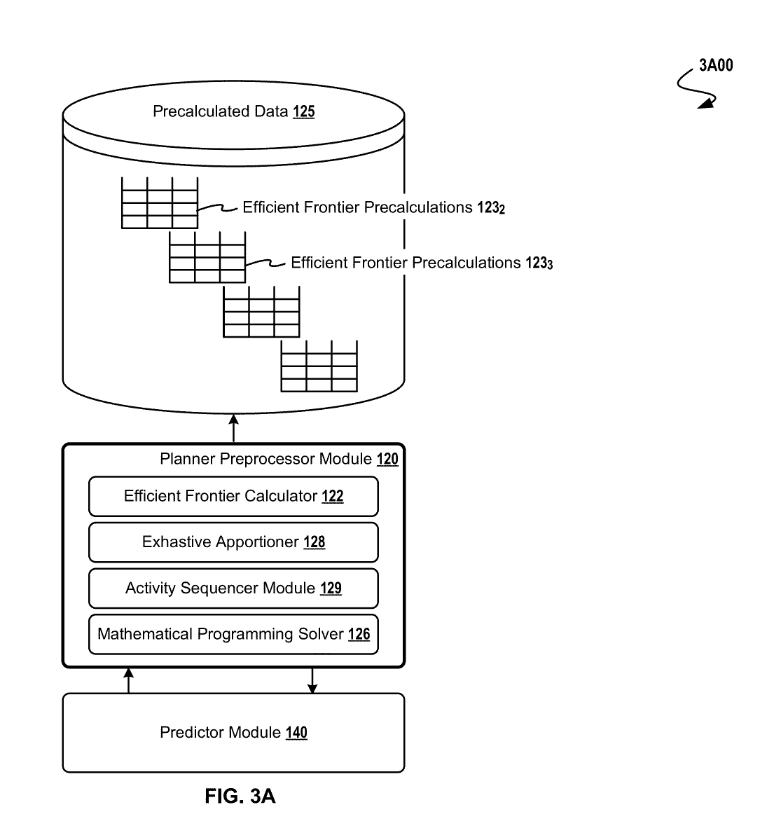

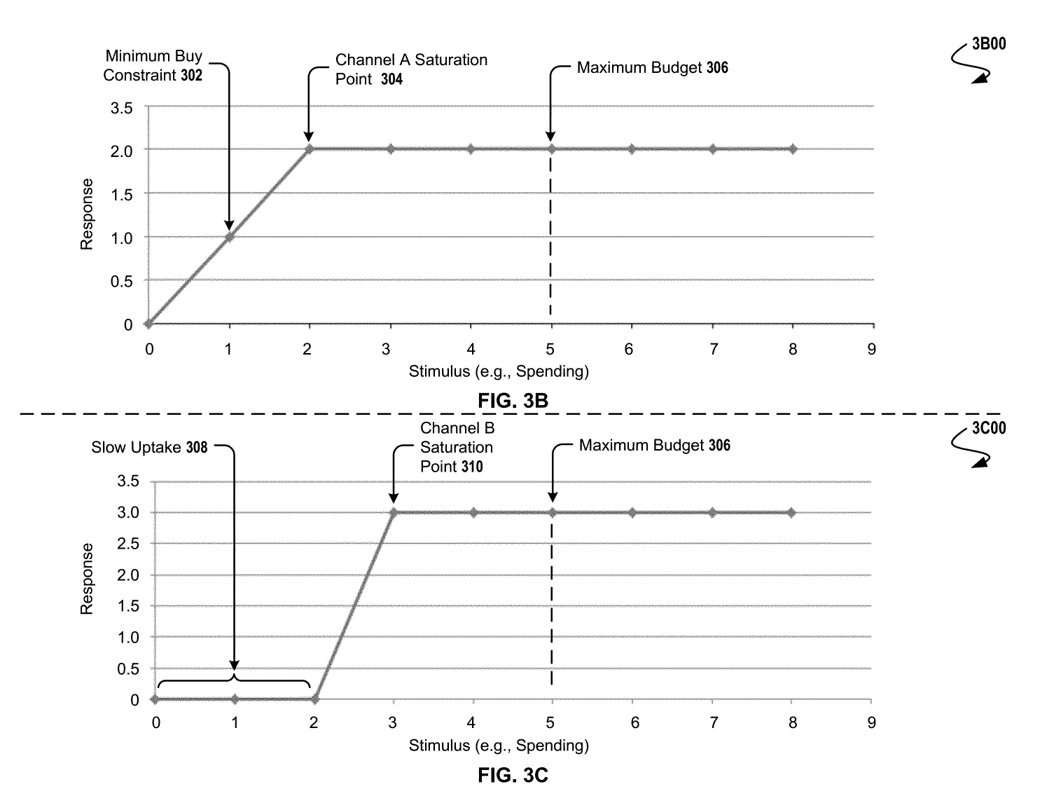

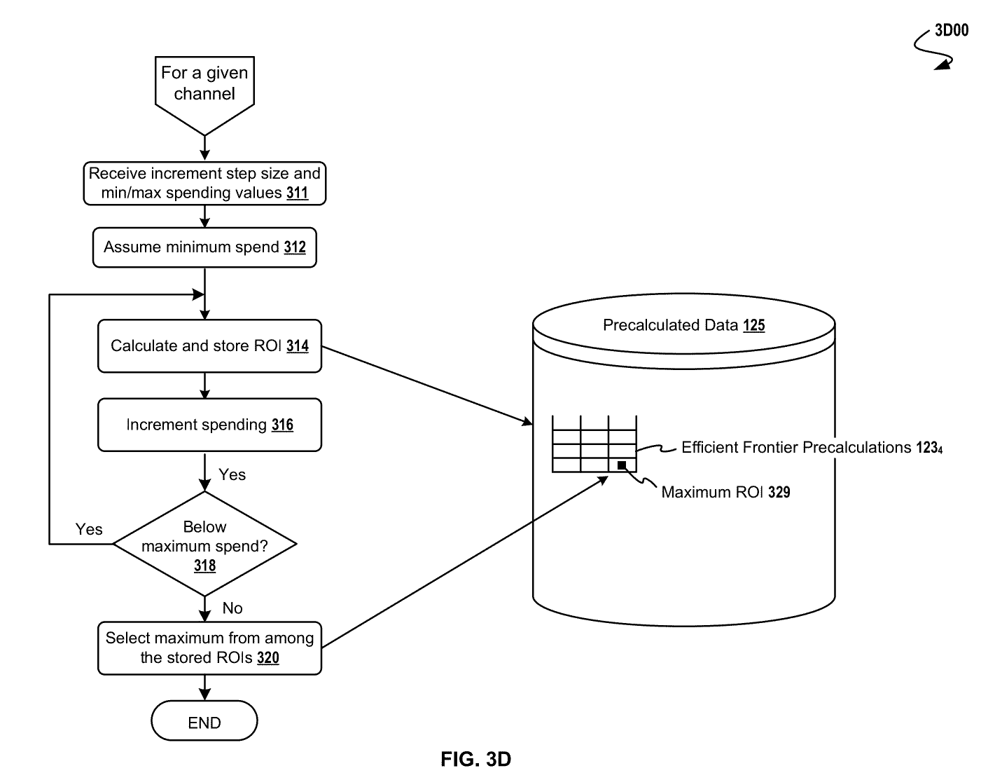

FIG. 3A is a block diagram of a subsystem 3A00 for precalculating efficient frontier data as used in systems for forecasting and displaying results of resource allocations in a marketing campaign. As an option, one or more instances of subsystem 3A00 or any aspect thereof may be implemented in the context of the architecture and functionality of the embodiments described herein. Also, the subsystem 3A00 or any aspect thereof may be implemented in any desired environment.

As shown, the planner preprocessor module 120 comprises an efficient frontier calculator 122 and an exhaustive apportioner 128. Any of the constituent components of the planner preprocessor module 120 can perform calculations and can store the results of such calculations in a storage location (e.g., precalculated data 125). The storage location can contain any organization of data, including tables, possibly in the form of one or more instances of precalculations (e.g., efficient frontier precalculations 123₂, efficient frontier precalculations 123₃, etc.).

The planner preprocessor module 120 interfaces with the shown predictor module 140, which in turn comprises a model (e.g., the model selected using configuration screen 200). The efficient frontier calculator 122 can use the predictor module 140 to determine a level of stimulus for each channel up until the response in the respective channel does not yield better results (e.g., when the channel does not yield an additional increased response). Or, in some cases, the planner preprocessor module 120 can use the predictor module 140 to determine a level of stimulus for each channel up until the first derivative of the response goes to zero or turns negative (e.g., reaches a local maximum). In such situations, the channel is considered to exhibit saturation behavior.

FIG. 3B depicts a stimulus-response curve 3B00 characterizing saturation behavior as used in systems for forecasting and displaying results of resource allocations in a marketing campaign.

The stimulus-response curve 3B00 shows a response (e.g., impressions, clicks, conversions, revenue, etc.) for a media channel A as a function of a stimulus (e.g., spending). In the specific example shown, the response initially increases linearly with spending until a saturation point is reached, after which even increased spending does not show an increase in response. This is deemed a saturation point (e.g., see channel A saturation point 304).

In some scenarios, spending might be constrained. For example, spending might be constrained (e.g., by the channel) with a minimum buy constraint 302, and/or spending might be constrained with a maximum budget 306. In a case such as is depicted, since the maximum budget 306 is larger than the channel A saturation point 304, a marketing manager might want to spend the remaining budget above channel A saturation point 304 in other channels. Channel B is such a channel. In this specific example, the shown channel B exhibits a slow uptake (see FIG. 3C).

FIG. 3C depicts a stimulus-response curve 3C00 characterizing slow uptake behavior as used in systems for forecasting and displaying results of resource allocations in a marketing campaign.

As shown in stimulus-response curve 3C00 for a media channel B, one unit of spending has zero response, and two units of spending also have zero response. However, three units of spending yield a non-zero response. This behavior is deemed to be exhibiting a slow uptake over the range of zero response from non-zero spending (see slow uptake 308). As shown, channel B also exhibits a saturation point (e.g., see channel B saturation point 310).

The behavior as depicted in the foregoing FIG. 3A and FIG. 3B may be captured in a model, and such a model may be formed from measurements of spending in a channel and measurements to quantify the response of the spending. In many cases, many channels are combined in a marketing program, and a marketing manager would want to know how to apportion the budget across the constituent channels in the marketing program. One technique to apportion spending or other stimulus over a plurality of channels in a marketing program is to apportion based on an efficient frontier. Spending in accordance with an efficient frontier seeks to apportion additional spending in a channel only until the spending begins to produce diminishing returns. One algorithm for calculating an efficient frontier for a marketing plan with multiple channels is presently discussed.

FIG. 3D depicts a data flow 3D00 for an efficient frontier algorithm as used in systems for forecasting and displaying results of resource allocations in a marketing campaign. As an option, one or more instances of data flow 3D00 or any aspect thereof may be implemented in the context of the architecture and functionality of the embodiments described herein. Also, the data flow 3D00 or any aspect thereof may be implemented in any desired environment.

The flow used for generating the efficient frontier data can be configured (e.g., using configuration screen 200) with values for:
A minimum controllable spend (e.g., a sum of all minimum buy constraints for each used channel);
A maximum controllable spend point (e.g., a budget); and
An increment step size.

As shown, the data flow 3D00 is executed iteratively over each channel to be considered in the marketing campaign. Initially, the processing receives a spending increment step size, and minimum and maximum spending values (see operation 311), and assumes an initial spending amount (e.g., the minimum spending amount) pertaining to the given channel (see operation 312). The response associated with the spending amount is determined (e.g., using the predictor module 140). The return (e.g., ROI) is calculated and stored (see operation 314). The amount specified as the aforementioned increment step size is allocated to the spending amount (see operation 316) and the response and return calculated and stored (again, see operation 314). A decision 318 determines if the loop is to be exited (e.g., incremented spending level exceeds the maximum spending value). When the loop is complete, the set of responses (e.g., ROIs) over the range of stimuli can determine, in part, an efficient frontier for a given channel, and can be stored as precalculated data 125 for later retrieval (e.g., in the set of efficient frontier precalculations 123₄). The set of stored ROI values is then checked, and the spending level returning the maximum ROI 329 is deemed to be at the efficient frontier (see selection of operation 320).

The data flow 3D00 is iterated over all channels in a media portfolio. Table 1 shows the results of executing data flow 3D00 over three channels (e.g., CH1, CH2, and CH3). The data flow 3D00 is first executed on CH1, calculating a CH1 efficient frontier at 500000, then executed on CH2, calculating a CH2 efficient frontier at 185000, and then executed on CH3, for which an efficient frontier level was not found within the maximum spending budget constraint.

TABLE 1
Efficient frontier calculation

| CH1 | CH1 | CH2 | CH2 | CH3 | CH3 |
|---|---|---|---|---|---|
| Spending | Frontier | Spending | Frontier | Spending | Frontier |
| Level | Amount | Level | Amount | Level | Amount |
| 200000 | | 85000 | | 1000000 | |
| 250000 | | 85000 | | 1000000 | |
| 300000 | | 85000 | | 1000000 | |
| 350000 | | 85000 | | 1000000 | |
| 400000 | | 85000 | | 1000000 | |
| 450000 | | 85000 | | 1000000 | |
| 500000 | 500000 | 85000 | | 1000000 | |
| 500000 | | 135000 | | 1000000 | |
| 500000 | | 185000 | 185000 | 1000000 | |
| 500000 | | 185000 | | 1050000 | |
| 500000 | | 185000 | | 1100000 | Not found |

Combining these results produces a curve depicting the most “yield to spend” ratio. Channel effects such as saturation are incorporated into the resulting “yield to spend” ratio curve.

It should be noted that the data flow 3D00 is merely one technique to calculate an efficient frontier. And, it should be noted that the application of the aforementioned efficient frontier algorithm over all channels in a portfolio may not result in an optimal allocation. In some cases spending at efficient frontier levels exceeds the maximum budget, and in some cases the selection of a first channel over which to iterate affects later results, and in some cases the selection of a first channel can prevent identification of any optimal allocation result. In some such cases (e.g., under user control), and to avoid some or all of the aforementioned shortcomings of an iterative approach to calculating an efficient frontier, an exhaustive search algorithm might be run to see if the efficient frontier points can be beaten (e.g., to give a better yield than iteratively-calculated efficient frontier points).

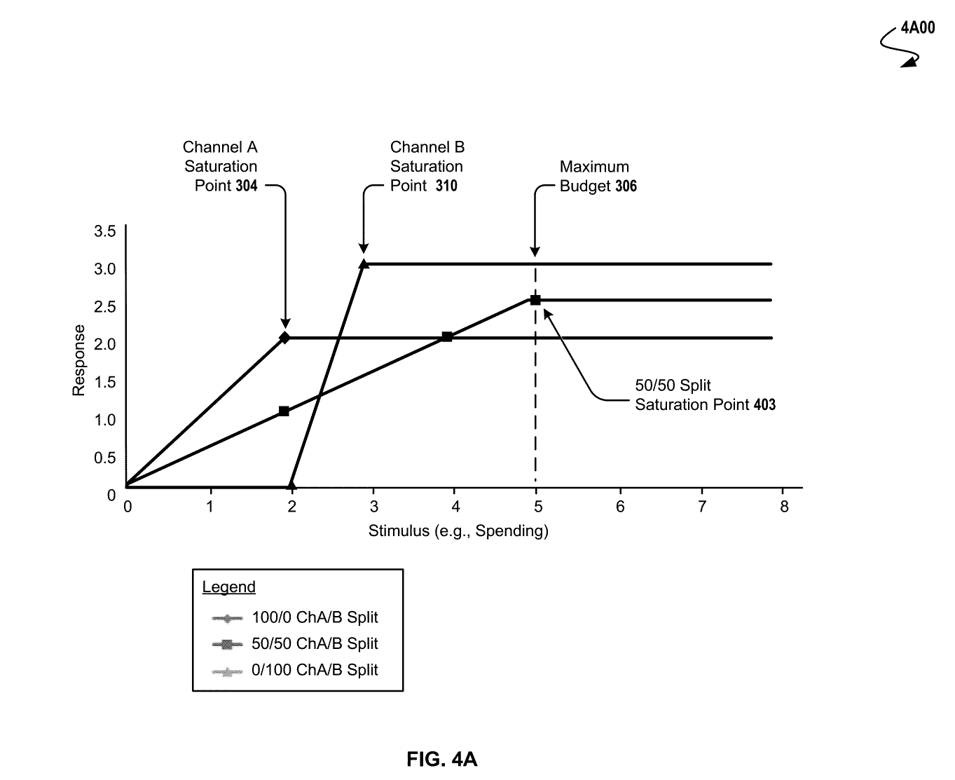

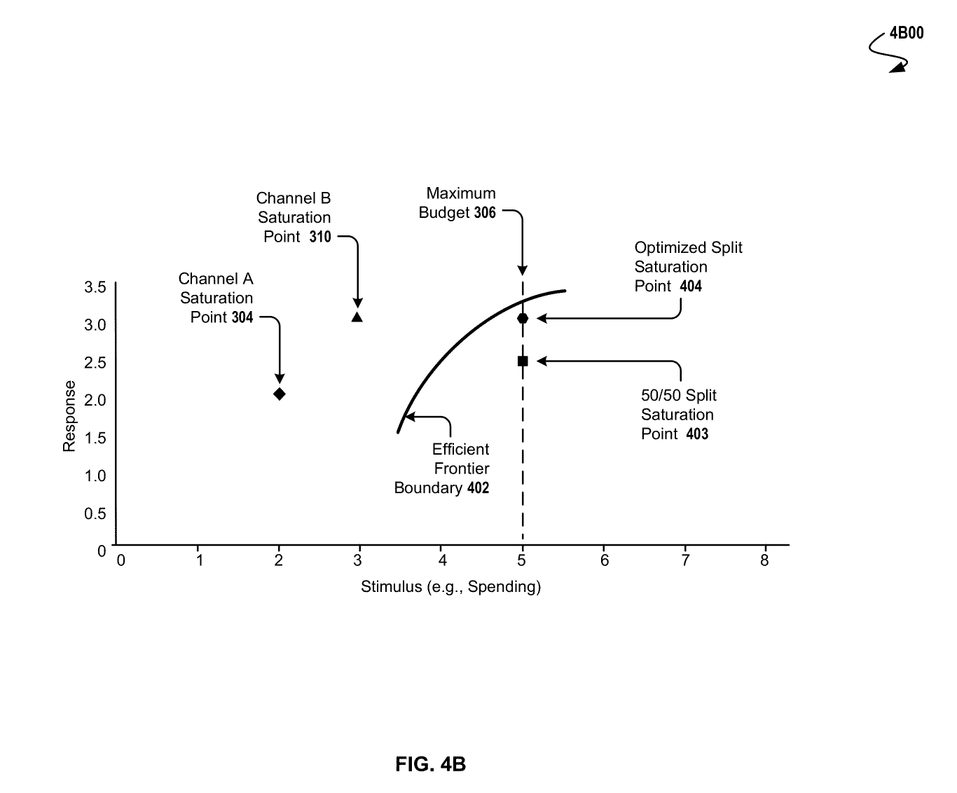

FIG. 4A depicts multi-channel responses 4A00 to apportioning stimulus across multiple channels as used in systems for forecasting and displaying results of resource allocations in a marketing campaign. As an option, one or more instances of multi-channel responses 4A00 or any aspect thereof may be implemented in the context of the architecture and functionality of the embodiments described herein. Also, the multi-channel responses 4A00 or any aspect thereof may be implemented in any desired environment.

With reference to the curves shown in FIG. 3B and FIG. 3C, and further considering the above-described efficient frontier algorithms, an efficient spending amount for channel A would not exceed the channel A saturation point 304 (e.g., Stimulus=2), since that is the point beyond which further spending in channel A does not yield an increased response. Also, an efficient spending amount for channel B would not exceed the channel B saturation point 310 (e.g., Stimulus=3), since that is the point beyond which further spending in channel B does not yield an increased response. A marketing manager can choose the apportioning of spending between channel A and channel B. The marketing manager might choose to allocate all spending up to the maximum budget 306 to channel A (e.g., “100/0 ChA/B Split”). In this case, the response will saturate at the channel A saturation point 304 and the remaining spending beyond a spending amount of 2 will be wasted. The marketing manager might also choose to allocate all spending up to the maximum budget 306 to channel B (e.g., “0/100 chA/B split”). In this case, the response will exhibit a slow uptake 308, and further saturate at the channel B saturation point 310, such that the remaining spending beyond a spending amount of 3 will be wasted. Splitting the spending evenly between channel A and channel B (e.g., “50/50 chA/B split”) will provide a linear response for initial spending levels, but will saturate at a 50/50 split saturation point 403 that is below the channel B saturation point 310 due to the constraint of the maximum budget 306.

As shown in this example, consideration of the efficient spending frontier of the media portfolio of channel A and channel B can produce better results than the aforementioned three allocation splits scenarios, as depicted in FIG. 4B.

FIG. 4B depicts improved multi-channel responses 4B00 to apportioning stimulus across multiple channels as used in systems for forecasting and displaying results of resource allocations in a marketing campaign. As an option, one or more instances of improved multi-channel responses 4B00 or any aspect thereof may be implemented in the context of the architecture and functionality of the embodiments described herein. Also, the improved multi-channel responses 4B00 or any aspect thereof may be implemented in any desired environment.

As shown in FIG. 4B, the channel A saturation point 304 and the channel B saturation point 310 can be analyzed to determine an efficient frontier boundary 402 for a media portfolio including channel A and channel B. As shown, the 50/50 split saturation point 403 is far from the edge of the efficient frontier boundary 402. However, an optimized split saturation point 404 can be close to the edge of the efficient frontier boundary 402 such that the return on investment of the spending is maximized. In the example shown, an optimized split of the maximum budget 306 might be a channel A spending amount of 2 (e.g., corresponding to channel A saturation point 304), and a channel B spending amount of 3 (e.g., corresponding to channel B saturation point 310).

Even though the optimized split (e.g., channel A stimulus=2, channel B stimulus=3) produces better results (e.g., closer to efficient frontier boundary 402) than splitting the budget evenly over the two channels, there may be cross-channel effects that are present, yet are not taken into account in embodiments of the efficient spending algorithms. In such cases, better outcomes can be achieved by apportioning spending variously to different channels (e.g., to take advantage of cross-channel effects). And, in some cases, an optimal spending amount can be determined using a known-in-the-art optimizer. Such an optimizer is depicted as a mathematical programming solver 126 (e.g., see FIG. 1D and FIG. 3A).

In certain cases, the mathematical programming solver 126 is not convenient to use (e.g., when the complete description of the problem to be optimized and/or the constraint set is not fully quantified). Yet, improved per-channel apportioned spending (e.g., a spending amount per channel) can be determined using an exhaustive apportioner 128 (e.g., see FIG. 1D and FIG. 3A). In some cases, an exhaustive set of scenarios can be calculated in real time. In other cases (e.g., when the number of channels is large and/or when the extent of the data set is large) it may be convenient to run a large number of scenarios and store the results as precalculated data 125 for later retrieval.

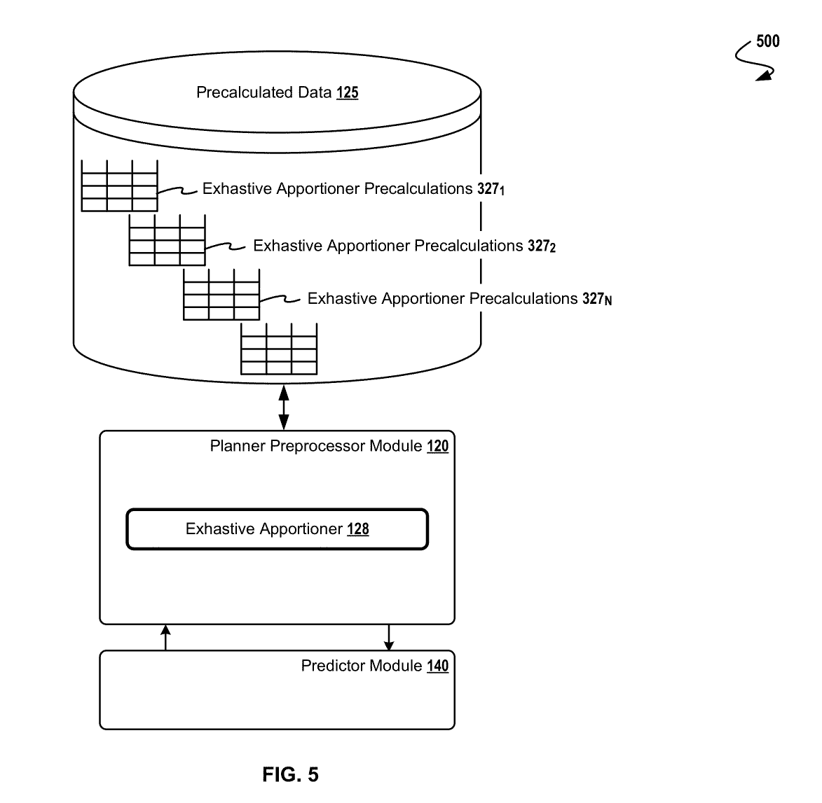

FIG. 5 is a block diagram of a subsystem 500 for precalculating exhaustive apportioner data as used in systems for forecasting and displaying results of resource allocations in a marketing campaign. As an option, one or more instances of subsystem 500 or any aspect thereof may be implemented in the context of the architecture and functionality of the embodiments described herein. Also, the subsystem 500 or any aspect thereof may be implemented in any desired environment.

As earlier indicated, an efficient frontier for spending can be calculated using a repetitive process of allocating a fixed amount onto individual spends based on maximum yield. This technique includes the effect that the newly generated points on the frontier are based on previous points. Under the conditions of a particular budget, the selection of which channel to consider first, and second, and so on can have a dramatic effect on the shape of the overall efficient frontier.

An exhaustive search algorithm can serve to address these requirements. Such an exhaustive search algorithm (e.g., executed by the exhaustive apportioner 128 in planner preprocessor module 120) can proceed by testing all possible combinations and reporting a channel-by-channel spending recommendation. If and when the newly generated spend recommendations are improved over any existing efficient frontier calculations, then the improved spending values can be used to form a maximum efficiency response curve (e.g., maximum efficiency response curve 151₁) and to form a corresponding maximum efficiency ROI curve (e.g., maximum efficiency ROI curve 152₁).

The computer processes for generating spend recommendations can become compute-intensive. In such a case, precalculated data 125 can be saved. As shown, the precalculated data 125 comprises various exhaustive apportioner precalculations (e.g., exhaustive apportioner precalculations 327₁, exhaustive apportioner precalculations 327₂, exhaustive apportioner precalculations 327_{N}, etc.).

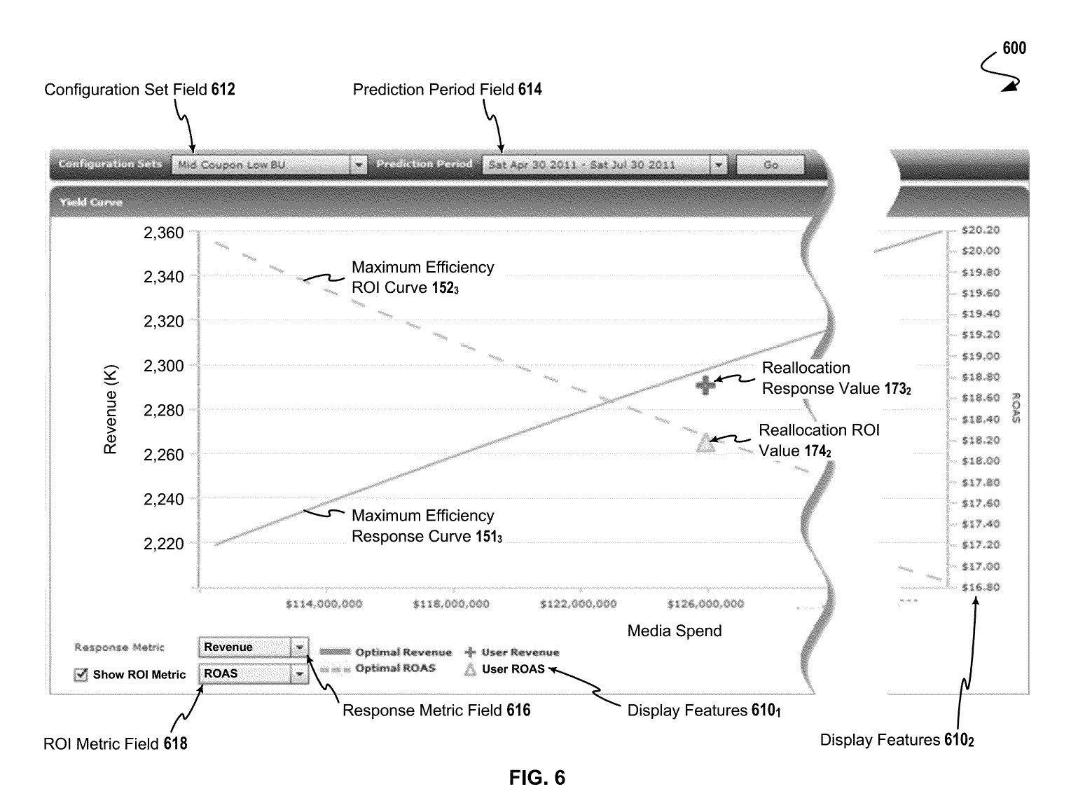

FIG. 6 shows reallocation values plotted in proximity to efficiency curves in an interactive interface 600 as used in forecasting and displaying results of resource allocations in a marketing campaign. As an option, one or more instances of interactive interface 600 or any aspect thereof may be implemented in the context of the architecture and functionality of the embodiments described herein. Also, the interactive interface 600 or any aspect thereof may be implemented in any desired environment.

A marketing manager might want to see various efficiency curves (e.g., response curves from an efficient frontier calculator, response curves from an exhaustive apportioner, etc.) and a marketing manager might want to see the apportioning of the spending. The marketing manager might also want to see the effects (e.g., ROI curves, etc.) of adjustments to or mixes of the recommended spending. As earlier indicated, what is needed is a technique or techniques to interactively display marketing campaign predictions (e.g., revenue changes) resulting from a particular interactively-set allocation/reallocation of spending in a media portfolio.

The interactive interface 600 serves to provide an interface for a user to interactively set allocation/reallocation of spending in a media portfolio and show reallocation values plotted in proximity to efficiency curves.

Strictly as one embodiment, the display components and their operation serve to address this need. In this specific embodiment, the following functions are shown and described:
A configuration set field 612 defines a particular configuration. Such a configuration set can result from user interaction with configuration screen 200.
A prediction period field 614 enables a selection of a date or a date range. The prediction period can fully overlap with a respective period covered by the learning model 141 used by the predictor module 140. Or, the prediction period can partially overlap with a respective period covered by the learning model 141 used by the predictor module 140. Or, the prediction period can cover a period that is fully outside of a respective period covered by the learning model 141 use by the predictor module 140.
A response metric field 616 can be a drop-down menu providing selection choices. The selection of a choice determines the underlying calculations to be performed and determines characteristics of the curves to be displayed (e.g., maximum efficiency response curve 151₃). The selection of a choice can also determine the dimension and scale of the left Y axis. Selecting an item in this drop-down menu can further determine the dimensions of the right Y axis. Responsive to the selection, default curves can be displayed. For example, calculations can be performed and a curve display can be displayed (e.g., maximum efficiency ROI curve 152₃). Other forms of maximum efficiency curves can be calculated and displayed, some examples and display variations of which are described below.
An ROI metric field 618 shows the variable and dimension of the right Y axis. Selecting a different item in this box modifies the curve and its labels (e.g., including dimension and scale) to reflect the selection. A show-hide checkbox associated with the ROI metric field 618 can further allow a user to toggle between showing or hiding the display features of a selected ROI metric. As depicted, the “Show ROI Metric” check box is checked and the display features (e.g., the shown display features 610₁ and display features 610₂, etc.) of the selected return on advertising spend “ROAS” appear on the interactive interface 600.
A reallocation response value 173₂ is depicted by a display component (e.g., a plus sign) that displays a point corresponding to a user reallocation (see FIG. 7A). A display component corresponding to the reallocation response value 173₂ is shown proximally in relation to the maximum efficiency response curve 151₃.
A reallocation ROI value 174₂ is depicted by a display component (e.g., a triangle) that displays a point corresponding to a user reallocation (see FIG. 7A). A display component corresponding to the reallocation ROI value 174₂ is shown proximally in relation to the maximum efficiency ROI curve 152₃.

As indicated in the foregoing, a user can reallocate spending or other stimulus across a plurality of channels. A user change in spending can be identified using display components (e.g., see the sliders of FIG. 7), and the predicted effects of such a reallocation can be simulated and displayed. Techniques for performing reallocations and for performing simulations are shown and described as pertaining to FIG. 7A and FIG. 7B.

FIG. 7A shows reallocation of resources across multiple channels using slider bars in an interactive interface 7A00 as used in forecasting and displaying results of resource allocations in a marketing campaign. As an option, one or more instances of interactive interface 7A00 or any aspect thereof may be implemented in the context of the architecture and functionality of the embodiments described herein. Also, the interactive interface 7A00 or any aspect thereof may be implemented in any desired environment.

The interactive interface 7A00 can be initialized to show default conditions and/or to show the apportionments across the channels of the portfolio that correspond to the channel-by-channel apportionment determined by an efficient frontier calculator (e.g., efficient frontier calculator 122) or by an exhaustive apportioner module (e.g., exhaustive apportioner 128). By interacting with interactive interface 7A00, a user can reapportion spending over the channels in the media portfolio and view the results (e.g., using emulation, using simulation, etc.) of such reapportioning in real time.

Specifically, and as shown, a user can enter a budget amount using a budget field 716 or by using a budget allocation slider 717. A default value for a budget can be determined via a calculation that chooses a mid-point between a user-defined minimum budget and user-define maximum budget. Such user-defined budget points can be defined in a configuration screen 200 (e.g., using the user minimum budget value 208 and the user maximum budget value 209). Budget values can be referred to indirectly via the configuration set.

Responsive to a change in the budget amount, the system displays an allocation. The allocation can be displayed as a percent of the budget (e.g., using sliders or other display components to show an arrangement of channel allocation indications 710), or the allocation can be displayed in the units of the budget (e.g., in dollars, as shown in column 740). When user allocations are established, the user can initiate activities that emulate a simulation (e.g., using the precalculated data 125) or perform a simulation.

The emulation or simulation activities serve to determine or predict the effect that the user allocations would have on the response of the media portfolio as a whole. The effects can be plotted using a reallocation response value 173₂ and a reallocation ROI value 174₂ (e.g., see FIG. 6). The emulation or simulation activities can be initiated by a user using the simulate button 730.

In some cases, a user might want to return the channel allocations to the channel-by-channel apportionment determined by an efficient frontier calculator or by an exhaustive apportioner module. In such a case, the user can interact with a display component to reset allocation (e.g., using reset allocations button 720). The user can again adjust allocations and interact with a display component to initiate simulation or emulation activities (e.g., using simulate button 730).

Returning to the discussion of user-defined budget values, it is possible for a user to indicate that a budget is “unknown”. In such a case, a default budget is determined. One approach to determining a default budget (e.g., a minimum budget) is to sum all of the minimum spend values as given through the entire portfolio, and use that value.

Any of a variety of known-in-the art techniques can be used to prevent unwanted overwriting of user values can be employed during user interaction.

### Sample Use Model

A use case proceeds a follows:
A user clicks on the reset allocations button 720 to reset the displayed values to depict values determined by an efficient frontier calculator or by an exhaustive apportioner module.
A user clicks on the simulate button 730. That action initiates activities to determine response metric numbers for the combination of the total budget and channel allocations as specified by the user. If the total of all channel allocations do not sum up to 100%, the user is prompted to further reapportion spending percentages to reach 100%. The channel allocations can be reapportioned to total 100% using any known technique.
A user interacts with one or more channel allocation indications 710 (e.g., using the per-channel allocation sliders). The shown interface supports channel allocation indications to be set to a value between the minimum budget and the maximum budget as defined in the configuration set.

Some embodiments support a display panel (see the tab labeled “Configuration Set Properties”). Such a display panel shows a read-only list of name-value strings describing the various attributes of the selected configuration set over a selected prediction period.

FIG. 7B shows a setting for an interactive reallocation of resources across multiple channels using slider bars in an interactive interface 7B00 as used in real-time marketing portfolio optimization and reapportioning. As an option, one or more instances of interactive interface 7B00 or any aspect thereof may be implemented in the context of the architecture and functionality of the embodiments described herein. Also, the interactive interface 7B00 or any aspect thereof may be implemented in any desired environment.

The example depicts the situation after a perturbation event. In this example, the perturbation event affected TV channel spending such that the maximum allowable spending on TV was reduced to [symbol] 5,500,000, and the media manager wants to quickly address the reduction in spending, yet, still wants to apportion the remaining spending across the other channels, and yet, still apportioning in an efficient manner. One way to reapportion in an efficient manner is to calculate a maximum efficiency curve with the new constraint (e.g., to reflect that the maximum allowable spending on TV was reduced to [symbol] 5,500,000).

Without initial conditions, such calculations may take a significant amount of elapsed time, making full recalculation of the efficient frontier undesirable in an interactive (e.g., real time) setting. The interactive interface 7B00 presents the results of portfolio spending reallocation where the efficient frontier had been previously calculated and stored (e.g., as precalculated data 125). More specifically, in an earlier session, components of a system as shown within user interaction environment 1D00 had already calculated a maximum efficiency response curve of a media portfolio, and had stored a representation of the maximum efficiency response curve to a storage device. Then, in an interactive session, an interactive interface (e.g., interactive interface 7B00) is presented to a user for accepting a change to alter the media portfolio input characteristics in the media portfolio. In the shown example, the specific change is to reduce spending on TV down to [symbol] 5,500,000. It should be recognized that the example of FIG. 7B presents a use case where the spending is displayed using denominations in EURO. In many situations spending can be apportioned over channels that may conduct business in one or another currency, and the display can present spending amounts in any currency of choice. Selection of one or another currency can be performed in a configuration session using a selector such as the aforementioned currency selection 211.

Now, as has been earlier disclosed, given the precalculated data 125, it is possible to perform interactive simulations of spending reapportionment scenarios, including recalculating of spending scenarios that consider the cross-channel effects as were stored in the precalculated data 125. Accordingly, next steps in the interactive session include retrieving the stored representation of the maximum efficiency response curve and applying the altered spending to the retrieved stored representation of the maximum efficiency response curve. The interactive interface 7B00 displays reallocation values based on the changed spending.

In some use models, the spending assigned to other channels is automatically apportioned. Or, in some use models, the interactive interface 7B00 accepts spending constraints in the form of a lock (see locks 741). Any of the spending on any of the channels (e.g., “Assets”, as shown) can be fixed (e.g., “locked”) and re-simulated.

For real-time interaction with a user, the fixed spending amounts can be considered as constraints to be honored while solving for an efficient frontier using any of the previously-stored instances of the plurality of efficient frontier precalculations 123 as a set of initial conditions in solving the multivariate optimization problem.

### Additional Practical Application Examples

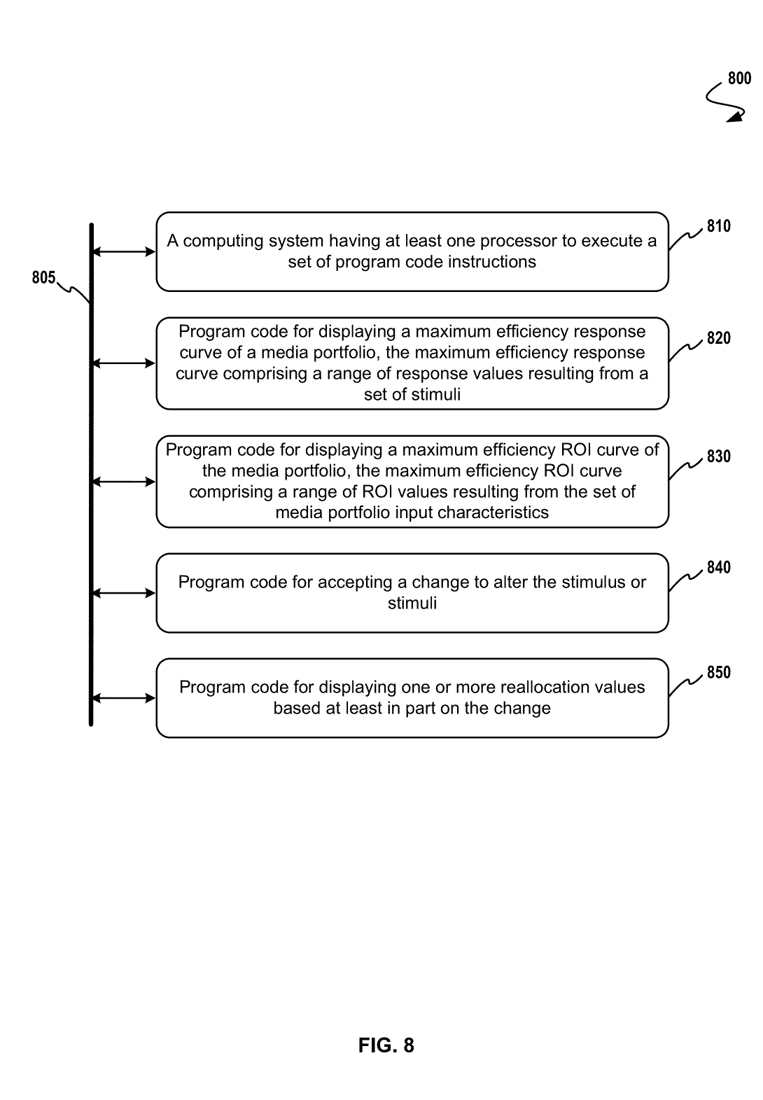

FIG. 8 is a block diagram of a system for displaying results of resource allocations in a marketing campaign, according to some embodiments. FIG. 8 depicts arrangements of computing modules that are interconnected so as to operate cooperatively for implementing any of the herein-disclosed embodiments. The partitioning 800 is merely illustrative and other partitions are possible.

As shown, an operation can be implemented in whole or in part using program instructions accessible by a module. The modules are connected to a communication path 805, and any operation can communicate with other operations over communication path 805. The modules of the system can, individually or in combination, perform method operations. Any operations performed may be performed in any order unless as may be specified in the claims. The embodiment of FIG. 8 implements a portion of a computing platform comprising one or more computer processors to execute a set of program code instructions (see module 810) and modules for accessing memory to hold program code instructions to perform: displaying a maximum efficiency response curve of a media portfolio, the maximum efficiency response curve comprising a range of response values resulting from a set of stimuli (see module 820); displaying a maximum efficiency ROI curve of the media portfolio, the maximum efficiency ROI curve comprising a range of ROI values resulting from the set of media portfolio input characteristics (see module 830); accepting a change to alter the stimulus or stimuli (see module 840); and displaying one or more reallocation values based at least in part on the change (see module 850).

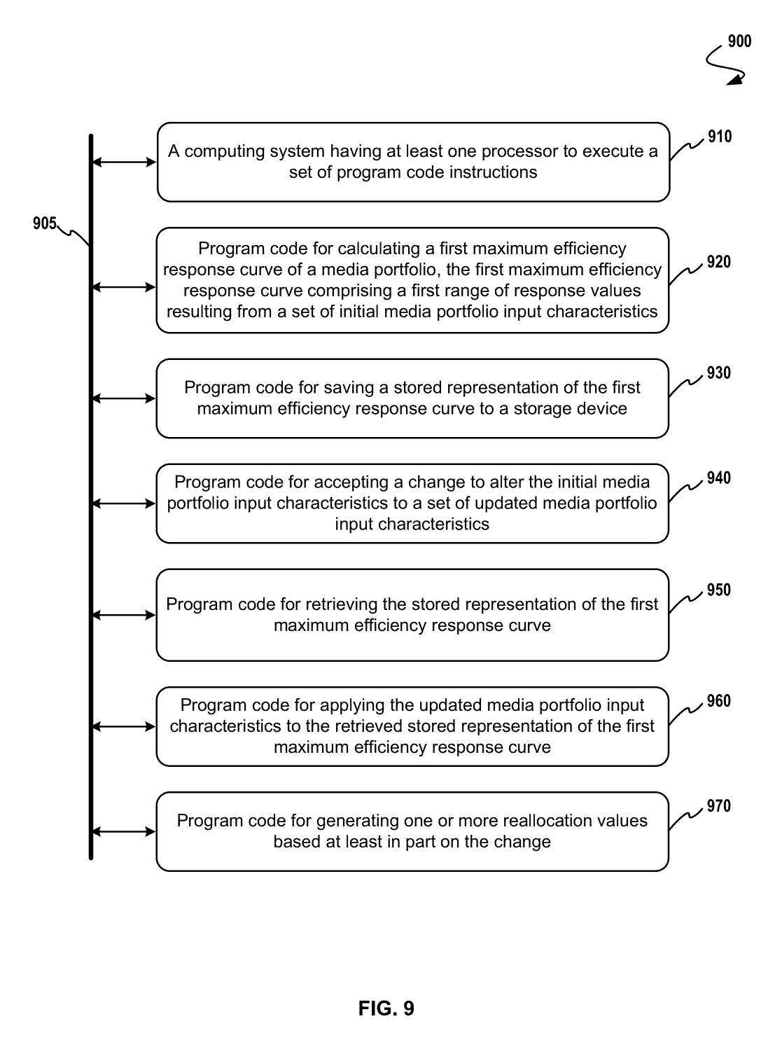

FIG. 9 is a block diagram of a system for generating and displaying results of resource allocations in real time for marketing portfolio optimization and reapportioning. FIG. 9 depicts arrangements of computing modules that are interconnected so as to operate cooperatively for implementing any of the herein-disclosed embodiments. The partitioning 900 is merely illustrative and other partitions are possible.

As shown, an operation can be implemented in whole or in part using program instructions accessible by a module. The modules are connected to a communication path 905, and any operation can communicate with other operations over communication path 905. The modules of the system can, individually or in combination, perform method operations. Any operations performed may be performed in any order unless as may be specified in the claims. The embodiment of FIG. 9 implements a portion of a computing platform comprising one or more computer processors to execute a set of program code instructions (see module 910) and modules for accessing memory to hold program code instructions to perform: calculating a first maximum efficiency response curve of a media portfolio, the first maximum efficiency response curve comprising a first range of response values resulting from a set of initial media portfolio input characteristics (see module 920); saving a stored representation of the first maximum efficiency response curve to a storage device (see module 930); accepting a change to alter the initial media portfolio input characteristics to a set of updated media portfolio input characteristics (see module 940); retrieving the stored representation of the first maximum efficiency response curve (see module 950); applying the updated media portfolio input characteristics to the retrieved stored representation of the first maximum efficiency response curve (see module 960); and generating one or more reallocation values based at least in part on the change (see module 970).

### Additional System Architecture Examples

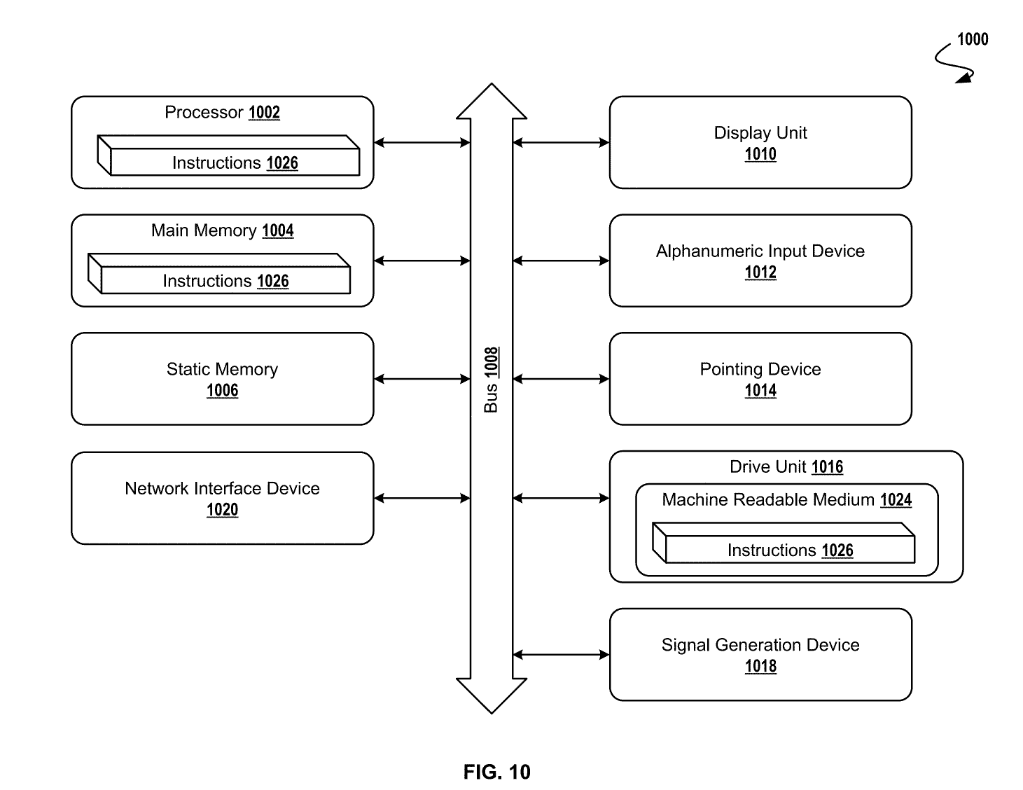

FIG. 10 depicts a block diagram of an instance of a computer system suitable for implementing an embodiment of the present disclosure. Specifically, FIG. 10 depicts a diagrammatic representation of a machine in the exemplary form of a computer system 1000 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., an LED display, or a liquid crystal display (LCD) or a cathode ray tube (CRT)), which can be used singly or in combination to form a single display surface or multiple display surfaces. The computer system 1000 also includes an alphanumeric input device 1012 (e.g., a keyboard), a pointing device 1014 (e.g., a mouse), a disk drive unit 1016, a signal generation device 1018 (e.g., a speaker), and a network interface device 1020.

The disk drive unit 1016 includes a machine-readable medium 1024 on which is stored a set of instructions 1026 embodying any one, or all, of the methodologies described above. The instructions 1026 are also shown to reside, completely or at least partially, within the main memory 1004 and/or within the processor 1002. The instructions 1026 may further be transmitted or received via the network interface device 1020.

The computer system 1000 can be used to implement a client system and/or a server system and/or any portion of network infrastructure.

It is to be understood that various embodiments may be used as or to support one or more instances of the set of instructions 1026 executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using any mix of any portions of the system memory, and any extent of hard-wired circuitry including hard-wired circuitry embodied as a processor 1002.

In the foregoing specification, the disclosure has been described with reference to specific embodiments thereof. Various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A system comprising:
a planner preprocessor module to calculate a first maximum efficiency response curve of a media portfolio, the first maximum efficiency response curve comprising a first range of response values resulting from a set of initial media portfolio input characteristics;
a data storage device to store a precalculated representation of the first maximum efficiency response curve;
an interactive planner interface module to accept a change to alter the initial media portfolio input characteristics to a set of updated media portfolio input characteristics; and
a predictor module to retrieve the stored representation of the first maximum efficiency response curve, and apply the updated media portfolio input characteristics to the retrieved stored representation of the first maximum efficiency response curve, and generate one or more reallocation values based at least in part on the change.

2. The system of claim 1, wherein the interactive planner interface module further operates to model the change as an incremental change record that is applied by the predictor module to the retrieved stored representation of the first maximum efficiency response curve.

3. The system of claim 1, wherein the change comprises a variation in one channel.

4. The system of claim 3, wherein the variation in one channel does not result in a recalculation of a second maximum efficiency response curve by the planner preprocessor module.

5. The system of claim 1, wherein the change comprises at least one of, an allocation change, a spending change, a budget change, and an advertising cost change.

6. The system of claim 1, further comprising an efficient frontier calculator to calculate the first maximum efficiency response curve using an efficient frontier algorithm.

7. The system of claim 1, further comprising an exhaustive apportioner to calculate the first maximum efficiency response curve using an exhaustive apportioner algorithm.

8. A computer program product embodied in a non-transitory computer readable medium, the computer readable medium having stored thereon a sequence of instructions which, when executed by a processor causes the processor to execute a process, the process comprising:
calculating a first maximum efficiency response curve of a media portfolio, the first maximum efficiency response curve comprising a first range of response values resulting from a set of initial media portfolio input characteristics;
saving a stored representation of the first maximum efficiency response curve to a storage device;
accepting a change to alter the initial media portfolio input characteristics to a set of updated media portfolio input characteristics;
retrieving the stored representation of the first maximum efficiency response curve;
applying the updated media portfolio input characteristics to the retrieved stored representation of the first maximum efficiency response curve; and
generating one or more reallocation values based at least in part on the change.

9. The computer program product of claim 8, wherein the change is modeled as an incremental change record that is applied to the retrieved stored representation of the first maximum efficiency response curve.

10. The computer program product of claim 8, wherein the change comprises a variation in one channel.

11. The computer program product of claim 10, wherein the variation in one channel does not result in a recalculation of a second maximum efficiency response curve.

12. The computer program product of claim 8, wherein the change comprises at least one of, an allocation change, a spending change, a budget change, and an advertising cost change.

13. The computer program product of claim 8, wherein the first maximum efficiency response curve is calculated using an efficient frontier algorithm.

14. The computer program product of claim 8, wherein the first maximum efficiency response curve is calculated using an exhaustive apportioner algorithm.

15. A method comprising:
calculating a first maximum efficiency response curve of a media portfolio, the first maximum efficiency response curve comprising a first range of response values resulting from a set of initial media portfolio input characteristics;
saving a stored representation of the first maximum efficiency response curve to a storage device;
accepting a change to alter the initial media portfolio input characteristics to a set of updated media portfolio input characteristics;
retrieving the stored representation of the first maximum efficiency response curve;
applying the updated media portfolio input characteristics to the retrieved stored representation of the first maximum efficiency response curve; and
generating one or more reallocation values based at least in part on the change.

16. The method of claim 15, wherein the change is modeled as an incremental change record that is applied to the retrieved stored representation of the first maximum efficiency response curve.

17. The method of claim 15, wherein the change comprises a variation in one channel.

18. The method of claim 17, wherein the variation in one channel does not result in a recalculation of a second maximum efficiency response curve.

19. The method of claim 15, wherein the change comprises at least one of, an allocation change, a spending change, a budget change, and an advertising cost change.

20. The method of claim 15, wherein the first maximum efficiency response curve is calculated using an efficient frontier algorithm.
